(19) United States
(12) Patent Application Publication
(10) Pub. No.: US 2003/0113698 A1
(43) Pub. Date: Jun. 19, 2003

(54) Method and system for developing teaching and leadership characteristics and skills

(76) Inventors: Michael Von der Geest, London (GB); Katharine F. Nisbet, London (GB); Russell Hobby, Brighton (GB); Rebecca H. Johnson, Claygate (GB); Stephen Lams, London (GB)

Correspondence Address: Lewis F. Gould, Jr., Duane Morris LLP, One Liberty Place, Philadelphia, PA, 19103-7396, US

(21) Appl. No.: 10/016,905

(22) Filed: Dec. 14, 2001

(51) Int. Cl. G09B 7/00

(52) U.S. Cl. 434/322

(57) ABSTRACT

A method of assisting in development of an environment comprising the steps of receiving evaluation data for a environment from at least one individual participating in the environment, wherein the evaluation data represent impressions of the individual regarding the environment, and providing model data to an individual that is responsible at least in part for the environment. The model data represent one or more dimensions of the environment and are developed at least in part from the evaluation data. Each of the one or more dimensions is associated with at least one characteristic of the individual responsible for the environment. The method also includes the steps of receiving from the individual responsible for the environment a selection of at least one of the one or more dimensions and providing the individual responsible for the environment an action plan for improving at least one characteristic associated with the dimension.

### FIELD OF THE INVENTION

This invention relates to methods and systems for assisting in the development of an environment, and more particularly to a method and system for assisting in the development of environments effected by teaching and leadership characteristics and skills.

### BACKGROUND OF THE INVENTION

Several higher education institutions conduct student evaluations of teachers at the end of each class semester. Evaluation forms may be administered in paper form or through a similar form accessible via a local area network (LAN) of an institution. The students are typically asked to rank a respective teacher and class on varying criteria using a numerical scale. The students may also be asked to provide additional comments. This student feedback is then provided to the respective teachers and/or the teachers' supervisor (e.g., a dean or department head).

While this feedback may help an individual teacher asses particular deficiencies in his or her teaching skills, the comments and feedback elicited from the questions are generally not tailored to identify particular deficiencies in the classroom environment generally, where these deficiencies impede students from achieving their maximum potential. Further, the process does not identify the strengths and weaknesses of a teacher with respect to particular teaching characteristics that directly effect a classroom environment. Still further, such feedback processes generally merely provide raw or averaged feedback summaries and do not incorporate the feedback within a process that directly helps a teacher develop a plan for improving or developing specific teaching skills and behavioral characteristics that are known to improve the classroom learning environment for the students.

Similar deficiencies may be found with respect to the overall learning environment of a school, as compared to an individual classroom within a school. No system is known that allows an academic supervisor, such as a dean or principal, to identify particular deficiencies in the school environment where such deficiencies are known to impede the progress of the school, and thus of the students, or that allows the supervisor to develop a plan to improve particular leadership skills and behavioral characteristic that can positively effect the school environment.

Therefore, there is a need for an improved method and system for providing evaluation feedback to classroom teachers and supervisors, as well as a method and system that help classroom teachers and supervisors improve identified characteristics and skills in a manner that positively and directly effects the learning environment for the students, whether it be classroom specific or school-wide.

### SUMMARY OF THE INVENTION

A method of assisting in development of an environment comprises the steps of receiving evaluation data for the environment from at least one individual participating in the environment, wherein the evaluation data represent impressions of the individual regarding the environment, and providing model data to an individual that is responsible at least in part for the environment. The model data represent one or more dimensions of the environment. The model data are developed at least in part from the evaluation data and each of the one or more dimensions is associated with at least one characteristic of the individual responsible for the environment. The method also includes the steps of receiving from the individual responsible for the environment a selection of at least one of the one or more dimensions and providing the individual responsible for the environment an action plan for improving at least one characteristic associated with the dimension.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention as well as other information pertinent to the disclosure, in which:

FIG. 1 is a stylized overview of a system of interconnected computer networks;

FIG. 2 illustrates an exemplary home page for a classroom teacher who has been registered into the system of the present invention;

FIGS. 3A-6 illustrate examples of classroom climate model data presented to a classroom teacher;

FIG. 7 is an example of a display illustrating a classroom teacher's priority with respect to a plurality of classroom dimensions and the key message with respect to each classroom dimension;

FIG. 8 is an example of a display illustrating a classroom teacher's response to the model data provided for each classroom dimension;

FIG. 9 is an example of an interface for selecting climate dimensions for development;

FIG. 10 is an example of an interface for selecting characteristics for action;

FIG. 11 is an example of an interface for eliciting evaluation data from a student;

FIG. 12 illustrates an exemplary home page for a head teacher who has been registered into the system of the present invention;

FIG. 13 is an example of a display indicating the effect of leadership styles on school climate dimensions;

FIGS. 14A-14E illustrate examples of school climate model data presented to a head teacher;

FIGS. 15A-15C are examples of a display indicating the effect of leadership styles on school climate dimensions selected by the head teacher; and

FIG. 15D is an example of an interface for selecting a leadership style for development.

### DETAILED DESCRIPTION OF THE INVENTION

The Internet is a worldwide system of computer networks—a network of networks in which users at one computer can obtain information from any other computer and communicate with users of other computers. The most widely used part of the Internet is the World Wide Web (often-abbreviated “WWW” or called “the Web”). One of the most outstanding features of the Web is its use of hypertext, which is a method of cross-referencing. In most Web sites, certain words or phrases appear in text of a different color than the surrounding text. This text is often also underlined. Sometimes, there are buttons, images or portions of images that are “clickable.” Using the Web provides access to millions of pages of information. Web “surfing” is done with a Web browser; the most popular of which presently are Netscape Navigator and Microsoft Internet Explorer. The appearance of a particular website may vary slightly depending on the particular browser used. Recent versions of browsers have “plug-ins,” which provide animation, virtual reality, sound and music.

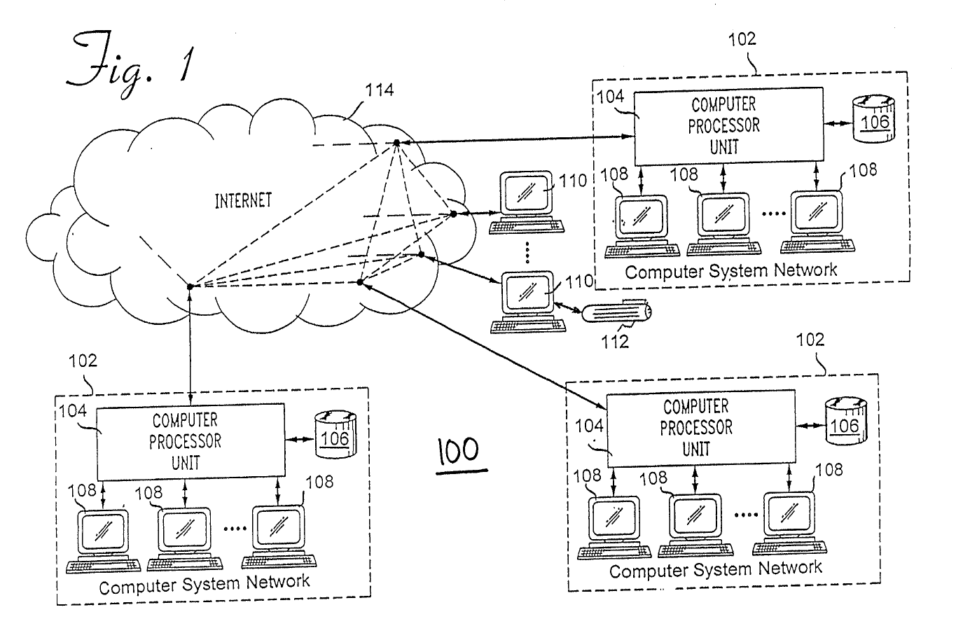

FIG. 1 shows a system 100 of interconnected computer system networks 102. Each computer system network 102 contains a corresponding local computer processor unit 104, which is coupled to a corresponding local data storage unit 106, and local network users 108. A computer system network 102 may be a local area network (LAN) or part of a wide area network (WAN) for example. The local computer processor units 104 are selectively coupled to a plurality of user devices 110 through Internet 114 described above. Each of the plurality of user devices 110 may have various devices connected to their local computer systems, such as scanners, bar code readers, printers, and other interface devices 112. A user device 110, programmed with a Web browser or other software, locates and selects (such as by clicking with a mouse) a particular Web page, the content of which is located on the local data storage unit 106 of a computer system network 102, in order to access the content of the Web page. The Web page may contain links to other computer systems and other Web pages.

The user device 110 may be a microprocessor-based computer terminal, a pager that can communicate through the Internet using the Internet Protocol (IP), a Kiosk with Internet access, a connected personal digital assistant, or PDDA, (e.g., a PALM device manufactured by Palm, Inc.) or other device capable of interactive network communications, such as an electronic personal planner. User device 110 may also be a wireless device, such as a hand-held unit (e.g., cellular telephone) that connects to and communicates through the Internet using the wireless access protocol (WAP).

The system and method of the present invention may be implemented by utilizing the system 100 described above in connection with FIG. 1. It should be apparent to one of ordinary skill that the system may be incorporated in a LAN, in a WAN, or through an Internet 114 based approach, such as through a hosted or non-hosted application service, or through a combination thereof. The functionality of the method may be programmed and executed by a computer processor unit 102, with necessary data and interface pages as described hereafter stored in and retrieved from a data storage unit 106. A user can access this functionality using a user device 110 or computer terminal 108.

The system and method of the present invention are described hereafter with respect to two exemplary embodiments—first with respect to a system modeled for a classroom teacher and second with respect to a system modeled for a head teacher. It should be understood that the system and method are equally applicable to primary schools (e.g., kindergarten through eighth grade), secondary schools (e.g., ninth through twelfth grades), and college and graduate schools. These schools may be departmentalized and generally offer a plurality of classes, e.g., a fourth grade class, a math class, a French class, a gym class, etc. A single classroom teacher is generally responsible for an individual class, although in some instances, such as when a classroom teacher has an assistant, more than one classroom teacher is responsible for a class. A head teacher, such as a principal, a president, a headmaster, a dean, or superintendent of schools, generally is responsible for the school as a whole, group of schools, or a group of classes, and is responsible for supervising all or some of the classroom teachers, other head teachers, and/or other employees, such as secretaries, accountants, janitors, coaches, etc.

### Classroom Teacher

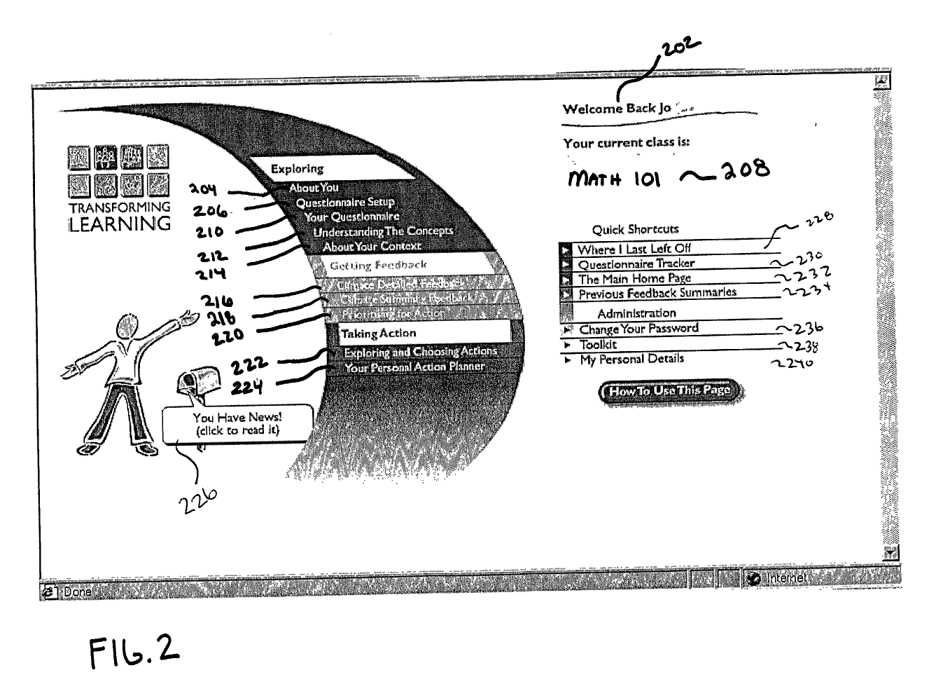

FIG. 2 illustrates an exemplary home menu screen, e.g., home page, for a classroom teacher who has been registered into the system 100. The menu screen provides an excellent framework for describing an exemplary system and method for assisting a classroom teacher in developing his or her teaching characteristics and skills. A classroom teacher may access her home page using a user device 10 or computer terminal 108. For example, the user may access a host computer network 102 that provides the functions of the system through a Web site by using a browser enabled user device 10. The system preferably requires a password and user name in order to limit access, so that the home page can be customized for the classroom teacher and so that any data associated with the classroom teacher may be retrieved from a database 106 and stored to a database 106 for association with the classroom teacher. The classroom teacher preferably establishes a username or password in an initial registration process described below. Each option provided through the home page may provide a link to the functionality of a software module that interacts with a teacher via pages of text displayed using a user device.

It can be seen from greeting 202 displayed to the classroom teacher that the menu screen is customized for a classroom teacher having the name “Jo.” The home page indicates at 208 that the home page is associated with Jo's class “Math 101.” Jo may teach several classes, and she may choose during a registration process to use the present system with respect to one, all, or some of her classes. Each class may have a different password and/or user name associated with it so that the home page may be customized accordingly and so that correct data may be retrieved from and stored to database 106.

After the classroom teacher has established a user name and password associated with a specific class (as shown by 208), the classroom teacher can access the functionality provided by the “About You” option 204. The menu screen, and indeed the functionality of the system generally, is preferably accomplished in a user friendly graphical user interface environment where various options may be selected by a user by, for example, “clicking” on the options with a mouse or other input device. If the user selects option 204, the user is provided the option of recording her teaching and social aspirations. This information is stored in a database 106 and associated with the classroom teacher. Once recorded, these aspirations may be revisited or modified by reselecting option 204.

The following are examples of questions which may be posed to a classroom teacher in order to identify the teacher's aspirations: (a) “What first inspired you to go into teaching?”; (b) “What have been your aspirations for life outside of work?”; (c) “Imagine that in 20 years time you meet a student who started in your class this year. That student says you were the best teacher ever and gives examples of what you did. What examples does your former student give?”; (d) “What are your aspirations for life outside work over the next year?”; (e) “What would you personally like to achieve or change in the next year as a teacher?”; (f) “How would you like your class to be different in a year's time?”; (f) “If money, health, responsibilities, longevity, etc. were not an issue, what would your ideal life look like 15 years from now?”; (g) “Ask yourself ‘What kind of person would I want to be in 15 years' time?’ (Again money, health, responsibilities, longevity are not an issue in your answer.”; and/or (h) “If age, health, and money were not an issue, and you see yourself working in 10-15 years' time, what would you want your work to be like.” Reflection upon one's aspirations can help improve classroom and leadership skills. The information provided to this module by the classroom teacher may be provided to a classroom teacher through the feedback section (described below) to ensure that a classroom teacher's action plan (also described below) conforms to the classroom teacher's aspirations.

Once the classroom teacher has recorded her aspirations using option 204, the classroom teacher is preferably provided the option of setting up her student questionnaires through the “Questionnaire Setup” option 206. The “Questionnaire Setup” option 206 allows the classroom teacher to designate all or a cross-section of her students from a selected class—in this case “Math 101”—to answer questions pertaining to the class via the system. The teacher can also designate deadlines for response. The option 206 also preferably provides a tracking function, whereby the teacher can check the status of the progress of each designated student, e.g., whether the student has completed the questionnaire, has begun the questionnaire, or has not begun the questionnaire.

The questions presented to the students and the classroom teacher are selected to elicit evaluation data with respect to the current condition and/or the ideal condition of the classroom climate, and particularly with respect to individual dimensions within the classroom climate. The concepts underlying the classroom climate and dimensions are described below. A list of possible questions or statements that may be provided to a group of secondary students follows:

1. Students who behave well are praised.

2. Students in Ms. Jo's class don't stay in their seats when they should.

3. When students don't understand something, it's easy for them to get help.

4. Students in Ms. Jo's class often work together in groups.

5. Students find what they learn boring.

6. Students pay attention in Ms. Jo's lessons.

7. The classroom is a neat and tidy place.

8. Students don't hurt each other after class.

9. Students in Ms. Jo's class want to learn more.

10. Ms. Jo's students are clear about what they should do for homework.

11. Ms. Jo's students are not expected to get all their work done.

12. The chairs and desks are not kept in good condition.

13. Students in Ms. Jo's class are not given clear explanations.

14. Ms. Jo's students who do their best are praised.

15. Students feel they learn lots of different, interesting things.

16. Students in Ms. Jo's class help one another learn.

17. Students in Ms. Jo's class only get blamed when they have done something wrong.

18. Ms. Jo's students are not expected to do their best on tests.

19. Ms. Jo's lessons start and finish on time.

20. Students in Ms. Jo's class are not encouraged to help one another.

21. Students are not clear about how what they are learning relates to what they have already learned in Ms. Jo's class.

22. In Ms. Jo's class excellent marks are easy to get.

23. The paintwork in the classroom is kept in good condition.

24. Students are allowed to discuss things in Ms. Jo's class.

25. In Ms. Jo's class students are not expected to hand their work in on time.

26. Students behave badly in Ms. Jo's class.

27. In Ms. Jo's class students are not expected to try really hard.

28. Students enjoy learning about new things in Ms. Jo's class.

29. Most students get a chance to present to the class.

30. Students say nasty things to one another in Ms. Jo's class.

31. The air can be stuffy in the classroom.

32. Students' work for Ms. Jo always gets marked fairly.

33. The classroom isn't kept nice and clean.

34. Students often work together on projects in Ms. Jo's class.

35. There is no bullying in Ms. Jo's class.

36. Students think the classroom looks really nice.

37. Ms. Jo's students are not clear about what they will be tested on.

38. In Ms. Jo's class some students get all of the praise.

39. Learning seems like fun in Ms. Jo's class.

40. Students are unclear about what they should have learned by the end of Ms. Jo's lessons.

41. Students do not damage other students' things in Ms. Jo's class.

42. In Ms. Jo's class students are not encouraged to improve.

43. Students in Ms. Jo's class are encouraged to say what they think.

44. Students do not steal things from each other in Ms. Jo's class.

45. Students are not clear about what they have just covered in Ms. Jo's class and what they will cover next.

46. The whiteboard/blackboard is cleaned up regularly.

47. In Ms. Jo's class when things don't work out, I do not feel encouraged to try again.

48. Students are not warm and friendly towards each other during Ms. Jo's class.

49. Students do not hit one another during Ms. Jo's class.

50. Students are not encouraged to ask questions.

51. Students help one another to solve problems.

52. Students feel they are treated fairly.

53. Students feel it's difficult to say when they don't understand something.

54. Students do not get excited about what they are learning.

55. Students feel other students don't stop them doing their work.

56. Students speak when they should not during Ms. Jo's lessons.

57. Students do not enjoy Ms. Jo's lessons.

58. Students do not look forward to coming to Ms. Jo's class.

59. My class is a happy place.

Responses may be provided on a rated scale that allows the students to indicate to what level each student agrees with the statement, e.g., on a scale from “1” to “5” where a “1” corresponds to “strongly agree” and a “5” corresponds to “strongly disagree.” Alternatively or additionally, some of the statements may be presented in the negative, e.g., for statement 59—“My class is not a happy place.” If a question is posed in both the positive and the negative, conflicting responses, i.e., a response that indicates a strong agreement with both the positive and negative statements, may be disregarded as inconsistent.

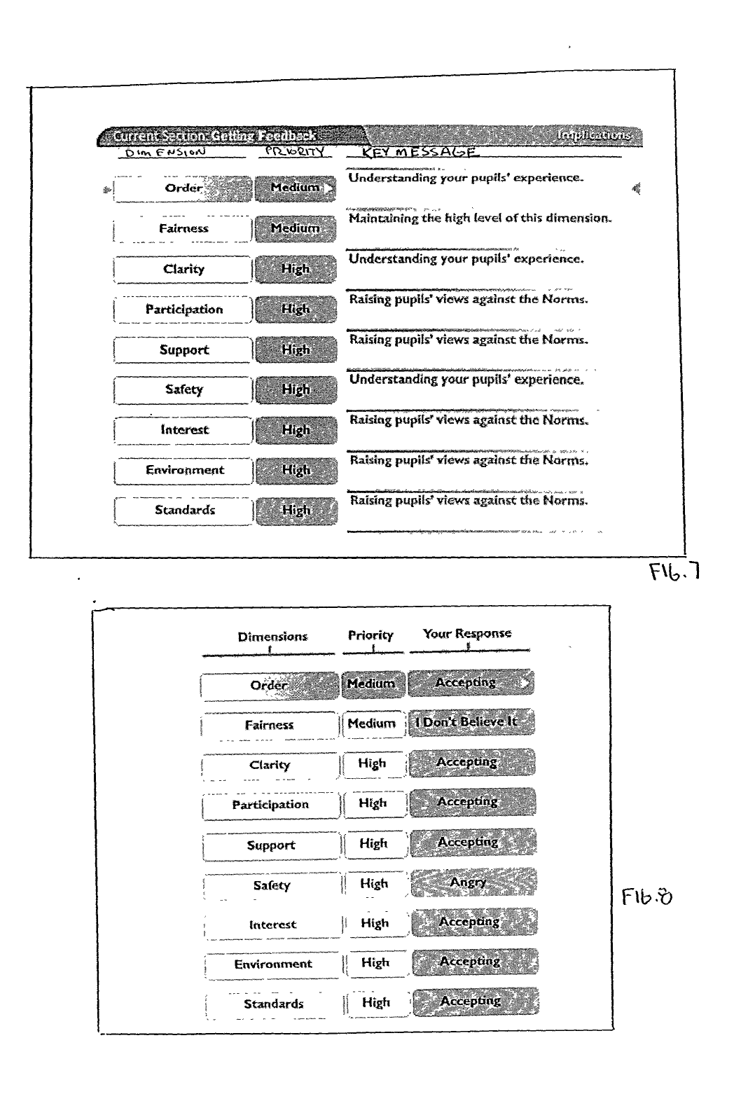

Another exemplary means of presenting a question is illustrated in FIG. 11. As illustrated in FIG. 11, the student is prompted to indicate his or her feelings concerning whether students are expected to hand work in on time. The student can agree with the statement that “In Ms. Osborne's class students are not expected to hand their work in on time” by selecting clickable option 1102. Alternatively, if the student agrees with the statement that “In Ms. Osborne's class students are always expected to hand their work in on time,” the student can select option 1104. If the student feels that the actual case is somewhere in between the two extremes, the student can select one of options 1106. FIG. 11 also illustrates a means of extracting ideal or desired future condition information from students. At 1108, the student is promoted in the same manner as described above to indicate how the student would like to see the particular classroom condition in the future.

Examples of questions or statements which may be posed to a group of primary students include the following:

1. Are you clear what Ms. Jo expects you to do?

2. Are you clear about the work you must get done for Ms. Jo?

3. Are you clear about the way you should behave in Ms. Jo's class?

4. Do the children pay attention in Ms. Jo's class?

5. Do the children behave well in Ms. Jo's class?

6. Do other children let you get on with your work in Ms. Jo's class?

7. Do you have to get your work done?

8. Are you told to do your very best?

9. Are you told to keep on trying even when the work is hard?

10. Is every child treated the same in Ms. Jo's class?

11. Do children get extra help if they need it?

12. Does every child get told well done?

13. Is it OK to ask questions?

14. Is it OK to say what you think?

15. Does everyone get a chance to say something?

16. Are children nice and friendly to one another in Ms. Jo's class?

17. Are children helped when they need help?

18. Do children help each other when they can?

19. Is it true that children don't bully other children in Ms. Jo's class?

20. Is it true that children are not nasty to one another in Ms. Jo's class?

21. Are children kind to each other in Ms. Jo's class?

22. Do you learn interesting things?

23. Do you enjoy your lessons?

24. Is it fun in Ms. Jo's class?

25. Is Ms. Jo's classroom neat and tidy?

26. Does Ms. Jo's classroom look really nice?

27. Is Ms. Jo's classroom clean?

28. Do you look forward to coming to class?

29. Is Ms. Jo's class a happy place?

30. Did you enjoy answering these questions?

As may be discerned from the above illustrated questions, questions are preferably presented to primary students in a manner designed to elicit a simple “yes” or “no” answer, rather than to elicit the level of agreement as requested of primary students. It is believed that primary students are better able to process “yes” or “no” questions.

The classroom teacher also preferably answers questions similar to those posed to the students by selecting the “Your Questionnaire” option 210, but the questions are addressed to the classroom teacher rather than the students. These questions are configured to identify the teacher's perception of the classroom environment for later comparison with that of the students, i.e., how the teacher believes her students currently perceive the classroom environment and/or how the teacher believes her students feel the ideal classroom environment should be.

The “Understanding the Concepts” option 212 provides a classroom teacher with information identifying how the system may be used to help her improve her teaching characteristics and skills, and thereby enhance her students' educations, as well as information concerning the conceptual framework upon which the system is founded. The classroom teacher is encouraged by the text provided to the teacher after selecting option 212 to take the necessary time to fully understand the concepts prior to receiving any feedback from the system. These concepts are described hereafter, with particular features of an exemplary option 212 described therewith

The framework of the system is premised on the idea that teachers should focus on improving their capabilities in areas that have a direct impact on the performances of their classes. Extensive research has been conducted by both the Hay Group—the assignee of the present application—and the United Kingdom into how highly effective teachers achieve results. This research has included classroom observation, in depth interviews with teachers and the use of focus groups, as well as the collection of personal and school data. Examples of this research can be found in Research into Teacher Effectiveness: A Model of Teacher Effectiveness, Research Report No. 216, Department of Education and Employment, Crown Copyright (2000), and at http://www.ncsl.org.uk/index.cfm?pageid=211 (visited Nov. 14, 2001: National College for School Leadership page). An analysis of the data revealed that three measurable factors influence classroom teacher effectiveness: teaching skills, teacher characteristics and classroom climate.

“Teaching skills” describe the craft of teaching. These skills can be learned, but sustaining them over the course of a career depends upon the deeper-seated nature of teacher characteristics. “Teacher characteristics” are deep-seated patterns of behavior which outstanding teachers display more often, in more situations and to a greater degree of intensity than average teachers do. The “classroom climate” represents the collective perceptions of students regarding the overall classroom learning environment. The climate provides information on students' perceptions of how it feels to be in a particular teacher's class in relation to every student's motivation to learn and perform to the best of his or her abilities. The more positive a climate, the more likely it is that students' progress and performance will match their raw potential. The results of the research indicate that, taken together, teacher skills, teacher characteristics, and classroom climate will predict over 30% of the variance in student progress. The system 100, therefore, allows a classroom teacher to obtain feedback on her classroom climate(s), as well as provides development suggestions based on professional characteristics.

Various teaching characteristics define highly effective teachers, whether utilized separately or in combination, and may collectively define a “Model of Effective Teaching.” The Model may be grouped into five clusters: (a) Professionalism; (b) Thinking; (c) Planning and Setting Expectations; (d) Leading; and (e) Relating to Others. “Professionalism” characteristics are related to a strongly held set of values held by highly effective teachers. Four teaching characteristics—(i) “challenge and support,” (ii) “confidence,” (iii) “creating trust,” and (iv) “respect for others may be included under the category of Professionalism.” The characteristic identified as “challenge and support” indicates a commitment to doing everything possible for each student to enable all students to be successful. “Confidence” indicates the belief in one's ability to be effective and to take on challenges. “Creating trust” indicates the characteristic of being consistent and fair, while adhering to one's word. Finally, “respect for others” identifies an underlying belief that individuals matter and deserve respect.

The category of “Thinking” characteristics recognizes that highly effective teachers think through information to select or develop an appropriate approach. Two characteristics—(i) “analytical thinking” and (ii) “conceptual thinking”—may be placed within this characteristic category. “Analytical thinking” represents the ability to think logically, break things down, and recognize cause and effect. “Conceptual thinking” represents the ability to see patterns and links, even when there is substantial detail.

The category of “Planning and Setting Expectations” recognizes that highly effective teachers channel their energy into targeting the key elements that make a difference to their students and the results they are able to achieve. Three teaching characteristics may be associated with this category—(i) “drive for improvement,” (ii) “information seeking,” and (iii) “initiative.” “Drive for improvement” is the characteristic of having relentless energy for setting and meeting challenging targets, for students and the school. “Information seeking” is a drive to find out more and get to the heart of things, i.e., intellectual curiosity. Last, “initiative” is the drive to act now to anticipate and preempt events.

The category of “Leading” recognizes that highly effective teachers take a roll in leading others. This category may be associated with four teaching characteristics—(i) “flexibility,” (ii) “holding people accountable,” (iii) “managing students,” and (iv) “passion for learning.” “Flexibility” is the ability and willingness to adapt to the needs of a situation and change tactics. “Holding people accountable” is the drive and the ability to set clear expectations and parameters, and to hold others accountable for performance. “Managing students” is the drive and ability to provide clear direction to students and to enthuse and motivate them. Finally, “Passion for Learning” is the drive and ability to support students in their learning and to help them become confident and independent learners.

The last category—“Relating to Others”—recognizes that highly effective teachers are able to relate to others. This category may be associated with three teaching characteristics—(i) “Impact and Influence,” (ii) “Teamworking,” and “(iii) “Understanding Others.” “Impact and Influence” is the ability and drive to produce positive outcomes by impressing and influencing others. “Teamworking” is the ability to work with others to achieve shared goals. Last, “Understanding Others” is the drive and ability to understand others and see why they behave as they do.

Highly effective teachers make the most of their professional knowledge by deploying appropriate teaching skills consistently and effectively during the course of their lessons. A range of teaching characteristics underpins the teaching skills. The measure of a classroom climate provides a key tool in analyzing the impact on students of a teacher's characteristics, skills and teaching methods in relation to various “dimensions” that collectively make up the classroom climate.

The classroom climate describes what it feels like to be a student in a particular teacher's class at a particular time. It encompasses factors that influence students' motivation to learn and perform to the best of their ability. These factors can be strongly influenced by the teacher. The classroom climate represents the collective perception of a class. The questionnaires provided to the students are designed to discern these perceptions so that the climate may be modeled. The questionnaires also preferably ask older students (e.g., eighth grade and higher) to indicate an ideal climate for the classroom, i.e., what they would like their class to be like in the future.

A classroom climate matters, because it correlates directly with student progress and has significant links to teaching characteristics. Extensive research, as discussed above, has shown that a classroom climate can be modeled by one or more dimensions or factors that have a statistically significant correlation with student achievement. For example, research has shown that a classroom climate can be modeled by nine dimensions that impact significantly on students' motivation—(a) clarity (the transparency and explicit relevance of what goes on in class); (b) order (discipline and structure in the classroom); (c) standards (expectations of achievement and encouragement to improve); (d) fairness justice and equality within the classroom); (e) participation (student involvement and influence in the running of the class); (f) support (encouragement to try new things and learn from mistakes); (g) safety (absence of threat or fear); (h) interest (stimulation and fascination in class); and (i) environment (the comfort and attractiveness of the physical environment).

In more detail, “clarity” is the extent to which students are clear about the aims and objectives of the course, the extent to which they understand the purpose of each lesson, the extent to which they know what is expected of them in their homework, and the extent that they can see how each lesson relates to the broader subject. “Order” is the extent to which discipline, order, punctuality and civilized behavior are maintained within the class. “Standards” is the extent to which students understand what is expected from them in terms of their performance and effort and the extent to which they are encouraged to improve their performance.

“Fairness” is the extent to which students perceive an absence of favoritism and a clear and consistent link between rewards, recognition in the classroom and their actual performance. “Participation” is the extent to which students feel that they are able to ask questions or offer opinions in class, the extent to which they have the opportunity to present to the class, and the extent to which they work together in groups. “Support” is the extent to which students feel emotionally supported in the classroom, both by their teacher and by one another, such that they are willing to try new things and learn from their mistakes.

“Safety” represents the extent to which students feel safe from emotional or physical bullying or other fear-arousing factors, both in the classroom and school environments. “Interest” is the extent to which students feel that the classroom is an interesting and exciting place to be and the extent to which they are stimulated to learn. Last, “Environment” is the extent to which students feel that the classroom is comfortable, well organized and maintained, e.g., a clean an attractive physical environment.

Once the teacher has reviewed the concepts behind the classroom climate, as described above, the “Understanding the Concepts” option 212 also preferably provides the teacher with narrative examples of how a climate dimension effects students. The teacher is also preferably provided the opportunity to apply her understanding of the concepts against real examples (e.g., case studies). Each case study presented to the classroom teacher shows a different situation with a different level of complexity. Once the teacher reviews a case study, she is prompted to identify the predominant climate dimension(s) evidenced in the study. A teacher's response is reviewed for its accuracy and explanation is preferably provided. The teacher ideally explores as many case studies as necessary until she is satisfied that she has a good understanding of what the climate dimensions look like in practice.

Option 214—“About Your Context”—prompts the classroom teacher to identify two personal incidents. This prompt preferably occurs after the teacher has reviewed case studies using option 212. The incidents may be, for example, a scenario when the teacher felt she succeeded as a teacher and a scenario when the teacher felt she failed as a teacher. Within option 214, the teacher is also prompted to respond to reflective questions regarding the incidents. Option 214 also allows the classroom teacher to revisit the two personal incidents for which the teacher detailed the first time the teacher accessed the “About Your Context” option 214. The teacher can edit any responses she provided regarding the incidents if desired. These responses are also preferably made available to the teacher during feedback and action planning, as described below, in order to help the classroom teacher consider her feedback and provide further reflective evidence for action planning.

After all of the student questionnaires have been completed via the system and the classroom teacher has completed her questionnaire, and preferably after the classroom teacher has thoroughly reviewed the material provided by the “Understanding The Concepts” option 212 and “About Your Context” option 214, the classroom teacher selects the “Climate Detailed Feedback” option 216. The format of the feedback provided to the classroom teacher is preferably explained to the classroom teacher in the “Understanding The Concepts” option 212. The climate feedback provided to the classroom teacher includes feedback for one or more of the classroom climate dimensions described above and preferably illustrates the following: (1) the gap between how the classroom teacher believes her students currently perceive the climate in her classroom and how the classroom teacher thinks they would like the climate to be like in the future; (2) the difference between the classroom teacher's perceptions and her students' perceptions of the current classroom climate; (3) the gap between the students' perceptions of the current classroom climate and how they would like the climate to be like in the future; and (4) the difference between the students' perception of the current classroom climate and a community benchmark of experience of classroom climates, such as on a national or regional level. Of course, other combinations may also be utilized, such as: (1) the gap between the perception of the students of the current classroom climate and how the classroom teacher thinks they would like the climate to be in the future; (2) a difference between the classroom teacher's perceptions of the current climate and an indication from the students of what the students would like the climate to be in the future; and (3) a difference between what the classroom teacher thinks the students would like the climate to be in the future and an indication from the students of what the students would like the climate to be in the future.

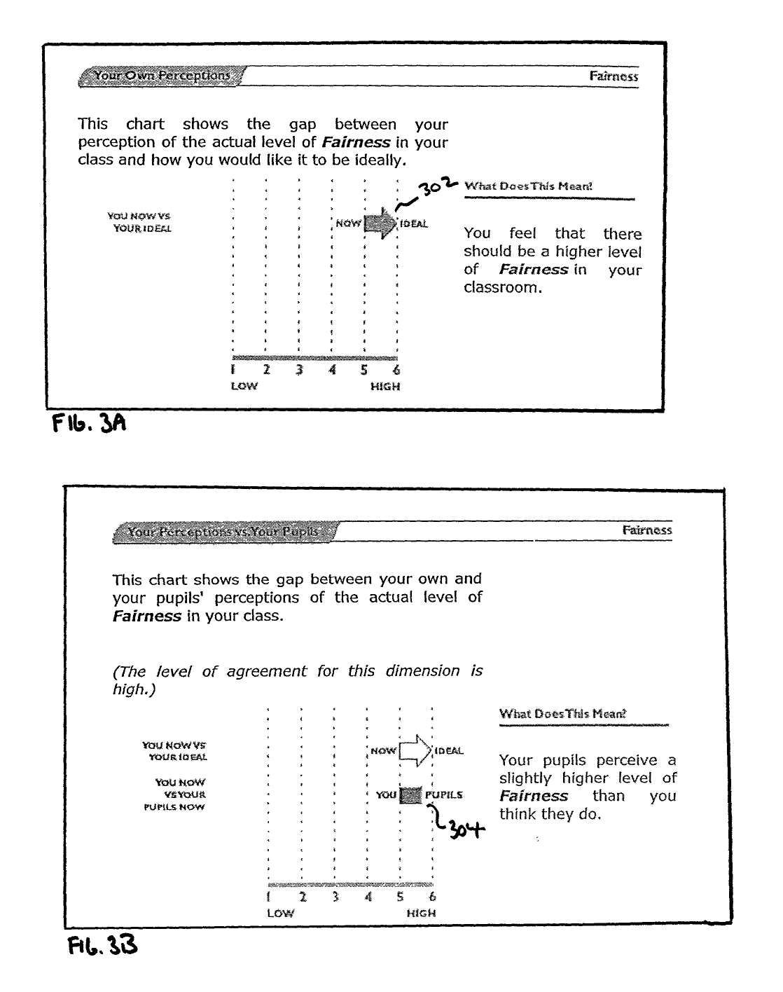

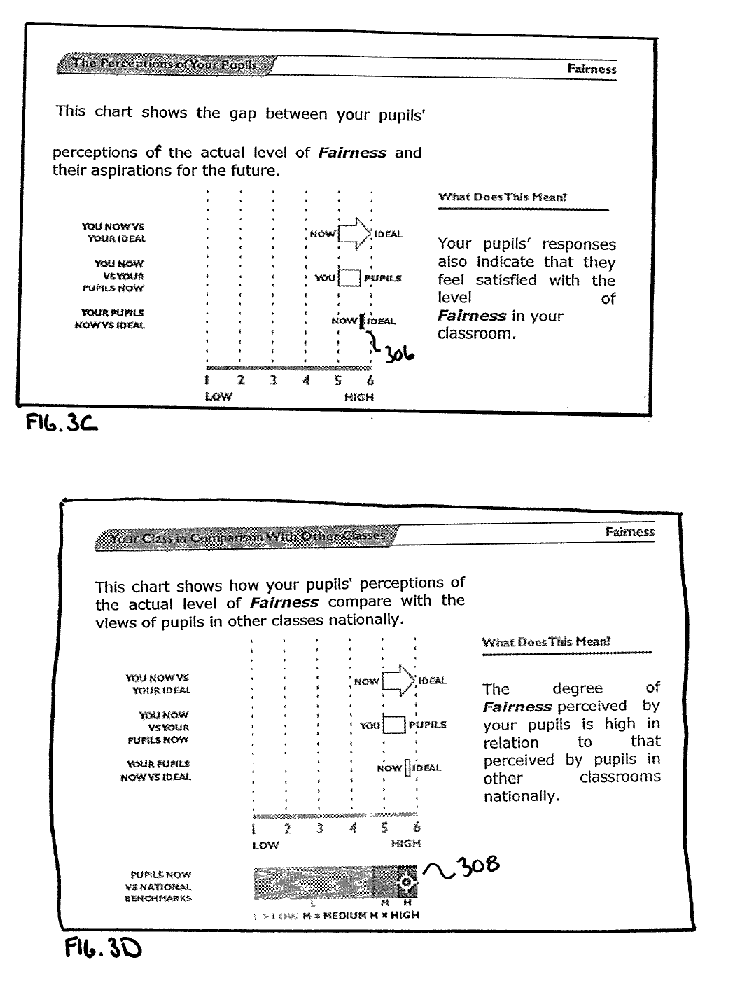

Model data representing one or more of the dimensions of the classroom climate and generated at least in part from the evaluation data received from the designated students and the teacher are preferably, although not necessarily, provided to the classroom teacher in a graphical format displayed to the classroom teacher on a monitor or other display of a user device 110 or 108 (FIG. 1). FIGS. 3A through 3E illustrate model data for the climate dimension “Fairness.” It should be understood that similar model data may be provided for each classroom dimension and that other manners of providing the model data are also appropriate, e.g., by different graphical, chart, or tabular method or in a purely textual or numerical format.

FIG. 3A is an example of the presentation of model data identifying the difference between how the teacher feels the students' perception of Fairness is in the classroom climate and how the teacher feels the students would like this dimension to be ideally. The chart indicates at 302 that the classroom teacher, as discerned from her evaluation data indicating her current perception of the classroom climate, feels that the students feel the Fairness level in the classroom is currently at a level of 5, with 6 being the high level and 1 being the low level. Of course, other numerical indicators or letter indicators, for example, could be utilized to identify relative levels. The chart of FIG. 3A also indicates that the teacher indicated in her evaluation data discerned from her questionnaire responses that she believes the students feel that the level of Fairness in the class should be higher—closer to a 6. Narrative feedback that accompanies the chart explains the purpose of the chart—“This chart shows the gap between your perception of the actual level of Fairness in your class and how you would like it to be ideally.” Further, additional narrative preferably explains to the classroom teacher the significance of what is shown on the chart—“You feel that there should be a higher level of Fairness in your classroom.”

FIG. 3B is an example of the presentation of model data identifying the gap or difference between the teacher's perception of the current level of the climate dimension Fairness and the students' perception of the current level of that climate dimension in the classroom. Again, this explanation is preferably provided along with a chart illustrating the model data. The chart of FIG. 3B indicates at 304 that the teacher's perception of the current level is approximately a 5 out of 6 (as is consistent with FIG. 3A) and that the students feel that the level of Fairness is closer to a 6. This indicates, as shown, that the students perceive a slightly higher level of Fairness than the teacher thinks they do. FIG. 3B also optionally shows the chart data indicated at 302 from FIG. 3A.

FIG. 3C is an example of the presentation of model data identifying the gap or difference between the students' perception of the actual level of Fairness in the classroom climate and the ideal level of this dimension indicated by the students in their evaluation data. The slight difference between the actual level perceived by the students and that desired by the students at 306 indicates that the students feel satisfied with the level of Fairness in the teacher's classroom. A determination of whether the chart indicates satisfaction can be made by the amount of numerical difference between the compared levels. One of ordinary skill should understand that this determination is guided by the research that underpins the determination of the climate dimensions and teaching characteristics that contribute to the climate dimensions and may be determined by application of an algorithm reflecting these concepts.

FIG. 3D is an example of the presentation of the model data identifying the difference between the students' perception of the level of Fairness in the classroom verses a community average, such as a “national benchmark.” The chart indicates at 308 that the students in Jo's Math 101 class have a high perception of the level of Fairness in Jo's Math 101 class when compared to the national benchmark (such as math classes generally in a country, classes generally in a country, 9^{th} grade classes generally in a country, etc.)

FIG. 3E is an example of a summary presentation of the model data presented to the classroom teacher in FIGS. 3A-3D that summarizes the status of the dimension in this particular classroom climate. Because the results as shown in FIGS. 3A-3D are “positive,” the summary directs the classroom teacher to try to maintain the positive climate dimension and work on dimensions that are not as strong while identifying opportunities to improve the classroom climate outside of the particular class—Math 101. The “Key Message” with respect to the Fairness dimension and “What Does This Mean?” message can be determined by an appropriate algorithm. For example, the gap between the current perception of the students and the teacher, the gap between the students' current perception and their ideal climate, and the relative gap between the students' perception and a national benchmark can be compared. The largest gap can be identified, and an appropriate message can be retrieved from a database 106 of messages. In this case, the most significant gap exists in the comparison of the students' current perception verses the national benchmark. The gap indicates that the students' current perception is very high with respect to national benchmark, and an appropriate message indicating that the results are “positive” and advising a course of action is indicated under “Your Key Message.” The “What Does This Mean?” message for the identified gap is also indicated. Because the students' perception verses a national benchmark gap is the most significant, this message is the same as that shown in FIG. 3D. Another possible algorithm first examines the gap indicated at 304: “you now vs your pupils now.” If that gap is above a certain threshold value, e.g., the difference is greater than 1, then that gap is used to generate the “key message.” If the gap is no above the predetermined threshold, then the gap at 306—“your pupils now vs ideal”—is examined. If that gap is above a predetermined threshold, then that gap forms the basis for selecting the “key message.” If the gap indicated at 306 is not significant enough, i.e., the gap is not above the threshold, then the national benchmark comparison at 308 is used as a default as the basis for the “key message.”

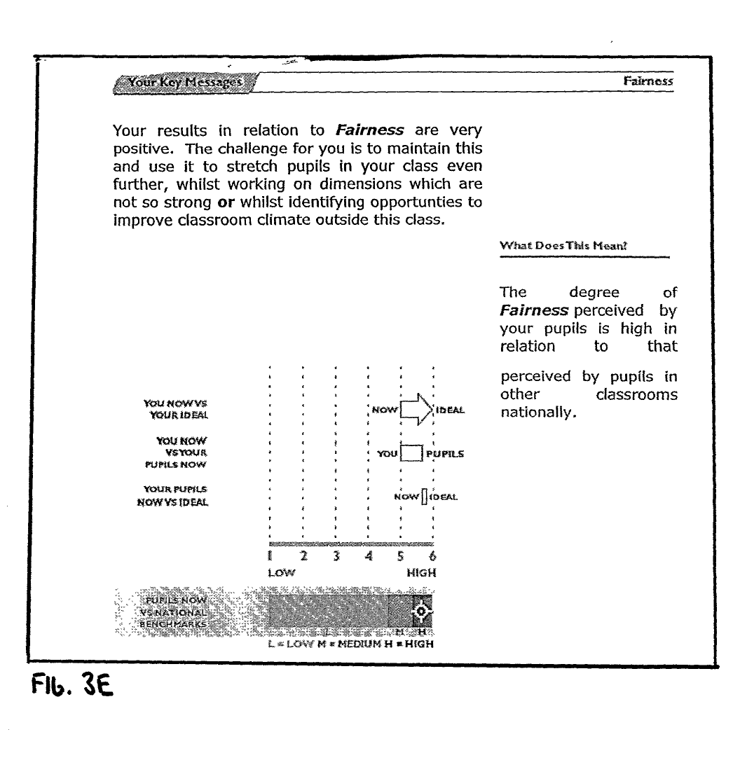

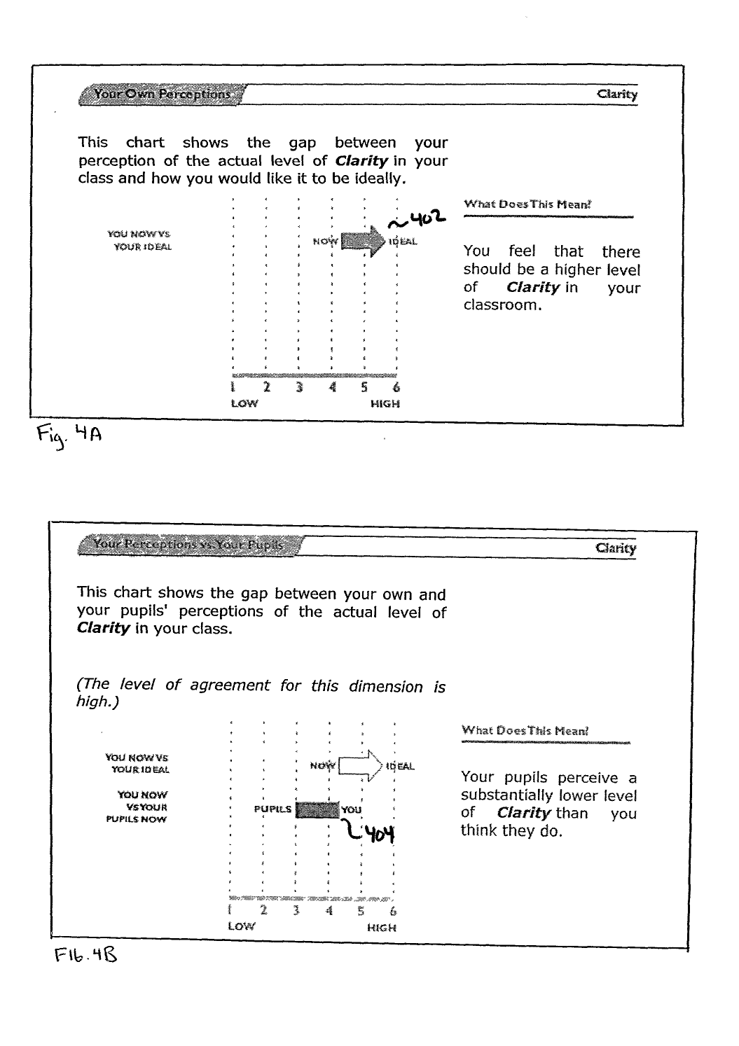

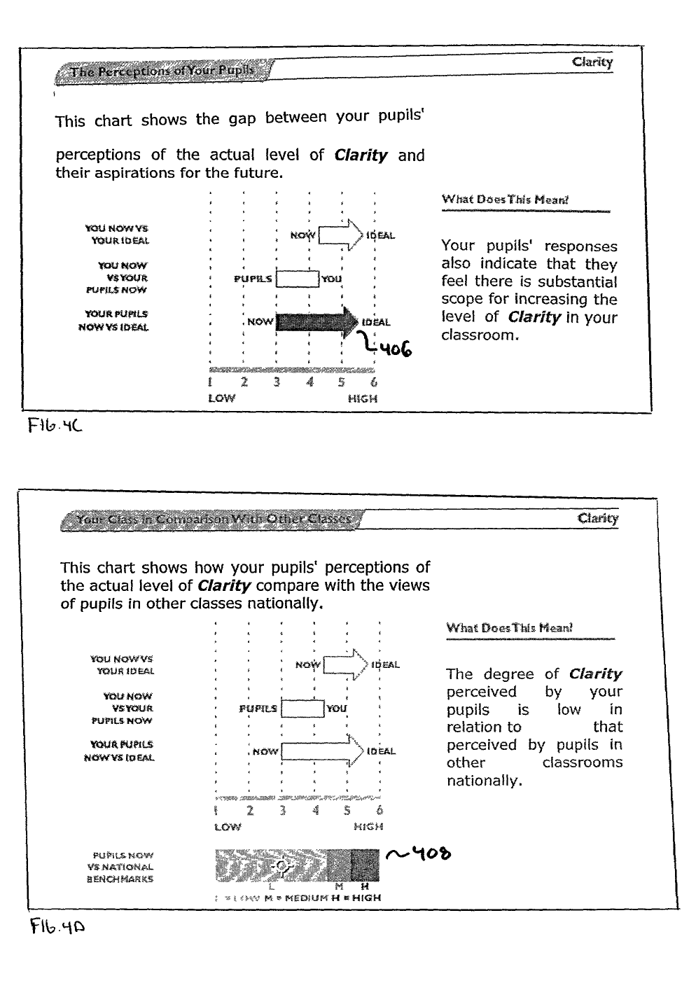

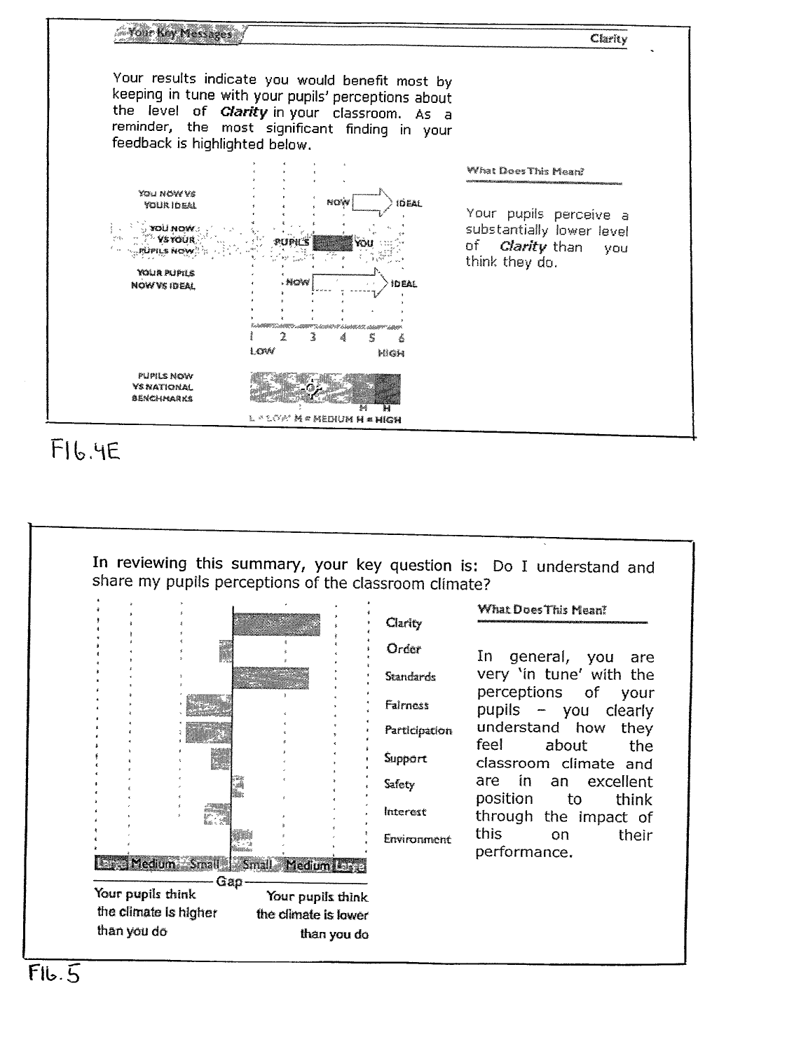

FIGS. 4A-4E provide a second example of the presentation of model data, particularly with respect to the climate dimension “Clarity.” FIG. 4A illustrates in chart or graphical format at 402 the difference between the teacher's perception of the students' perception of the level of Clarity in her classroom and the level that she believes the students feel would be ideal, as discerned from her questionnaire responses discussed above. The chart indicates a noticeable difference between where the teacher perceives the actual level of Clarity to be and where she feels is an ideal level of Clarity.

FIG. 4B illustrates at 404 the gap between the students' perceived level of clarity and that level the classroom teacher feels the students perceive. The difference indicates that the students perceive a substantially lower level of clarity than the classroom teacher feels they perceive. The chart also indicates that “The level of agreement for this dimension is high.” This message indicates that the students' responses regarding their perceptions of the current state of the climate dimension Clarity are highly consistent. This level of consistency may be gleaned from an analysis of the raw evaluation data received from the students, preferably while eliminating rogue data.

At 406, FIG. 4C indicates that there is a significant gap, according to the students, between the actual level of clarity in the classroom and what the students feel would be an ideal level of clarity. FIG. 4D indicates at 408 that the students' perception of the level of clarity in the classroom is low when compared to a community average, such as a national or regional benchmark.

FIG. 4E summarizes a “key message” that the classroom teacher should discern from the model data provided in FIGS. 4A through 4D: “Your results indicate you would benefit most by keeping in tune with your pupils' perceptions about the level of Clarity in your classroom. As a reminder, the most significant finding in your feedback is highlighted below.” Like FIG. 3E, the particular model data that provide the basis for the “key message” are highlighted. Here, it is quite significant that the students' perceive a substantially lower level of clarity than the teacher thinks they do. FIG. 4E thereby illustrates that an algorithm is utilized to generate the “key message” that prioritizes significant gaps at 404—“you now vs your pupils now”—above other indicated gaps, being that the gap at 404 is not the largest indicated gap.

Once the classroom teacher has reviewed the model data for an individual classroom climate dimension, the system preferably prompts the teacher to register her feelings about the information that she has been provided. For example, the teacher may be prompted to select a statement that best summarizes her feelings, e.g., accepting, reflecting, upset, angry, or disbelief. After the teacher registers her feelings, the teacher may respond with narrative responses to reflective questions regarding the dimension. The narrative responses may be typed into a data entry “window” for example. This is particularly helpful when the teacher is angry or disbelieves the model data. The teacher may be presented with reflective questions, such as: “What steps might you take to gain a better insight into how your students perceive the level of (insert dimension) in the classroom?”; “What might underpin the aspirations of your students in terms of their desired level of (insert dimension)? What could you do differently to response to or manage these aspirations? What would be the benefits of doings so? What would be the implications of not doing so?”; and/or “What factors might influence your students' perception of (insert dimension) in the classroom climate compared to the perceptions of students in other classrooms nationally? It may help you to consider your class, your approach to teaching and the wider school environment. What action might you wish to take? What would be the benefits of doing so? What would be the implications of not doing so?”.

Last, after reviewing model data for each dimension, the classroom teacher is prompted to provide a priority level for the development of the respective dimension. For example, the classroom teacher may be prompted to provide whether she feels development of the dimension is a low, medium or high level of priority. All responses to the model data provided by the classroom teacher are stored in database 106 for later retrieval and use by the system. This review and response process is preferably repeated by the classroom teacher until model data for each classroom dimension has been reviewed by the classroom teacher.

FIG. 5 illustrates that the classroom climate may also be modeled as a comparison between dimensions of the relative gap between the classroom teacher's perception of each individual dimension and that of the students in the class. For the nine dimensions set forth above, the chart of FIG. 5 illustrates this gap for each dimension, whether the gap is relatively small, medium or large, and whether a respective gap indicates that the student thinks the climate dimension is higher than does the classroom teacher or vice versa. The key issue for the teacher, as indicated by FIG. 5, is whether the teacher understands and shares her students' perceptions of the classroom climate. The information provided to the classroom teacher in the chart is also preferably summarized for the teacher in narrative form, as shown in FIG. 5. The narrative of FIG. 5 indicates that the teacher is generally “in tune” with the perceptions of her class. This conclusion may be discerned from the absence of any “large” gaps between the perceptions of students and the classroom teacher for any climate dimension and from the presence of only two “medium” gaps. Of course, a determination of whether a teacher is “in tune” or not in “tune” is made based upon a predefined algorithm, but guided by the research that supports the modeling of a classroom into the nine aforementioned dimensions. Also, the determination of whether a gap is small, medium or large is also relative and is guided by the research.

FIG. 6 illustrates that the model data provided to the classroom teacher may also provide a comparison between the classroom climate in a teacher's class and that of a community benchmark, such as a national or regional benchmark. The benchmark may be developed from evaluation and model data compiled from a plurality of schools. The data for each school may be used to rank schools or to assign a score to each school, such as on a dimension by dimension basis. When a dimension for a particular classroom is then compared against a community benchmark, the comparison can be made on a percentile level, i.e., by placing the dimension within a certain percentile of schools. For example, FIG. 6 illustrates at 602 that the dimension of Clarity is relatively low when compared with the national benchmark. More specifically, “low” may corresponds to the bottom 33% of schools and “high” may correspond to the top 33% of schools. The medium percentile (e.g., 33-67%) for the Clarity dimension falls somewhere within the shaded “medium” region indicated at 604. In contrast to the comparison of the level of Clarity in Jo's classroom against a national benchmark, the chart of FIG. 6 indicates at 606 that the climate dimension of Order is relatively “high” within the tested classroom, i.e., the level of the climate dimension falls within approximately the middle of the upper percentiles of schools. Again, the display of FIG. 6 preferably does not just provide the teacher with raw model data on the chart but instructs the teacher at 604 on how to process the data: “In reviewing this summary, your key question is: Is there scope to improve the climate in this class to match or exceed the climate in other classrooms nationally, or would I do better to focus my energies elsewhere?”. The summary chart of FIG. 6 is also summarized at 606 by indicating that overall the students perceive some strengths and weaknesses in the climate and that the feedback highlights some areas that may impede the students' performances. Such narrative analysis is provided from a database 106 of narrative analysis, as selectively recalled based upon an appropriate algorithm utilizing the model data. Referring to FIG. 2, the summary model data provided to the classroom teacher by FIGS. 5 and 6 may be accessed by selecting option 218—“Climate Summary Feedback.”

As described in connection with the model data provided to the classroom teacher for each individual dimension of the classroom climate, the classroom teacher is also preferably prompted to provide her reaction to the feedback presented in FIGS. 5 and 6, e.g., accepting, reflecting, upset, angry, or disbelief. The classroom teacher is preferably instructed to spend some time reflecting on events that the teacher has experienced in her class, particularly in light of the classroom climate the teacher is perceived to create. For example, the teacher can reflect upon the two incidents that she provided in the “About Your Context” option 214. The summary of the incidents and the teacher's reflection may be recalled from a database 106 for presentation to the classroom teacher. In order to help the teacher reflect on the model data, and thus the perceived classroom climate, in light of the prior recorded incidents, the teacher may be prompted to respond to a series of questions, such as by entering her responses in narrative form in a text box presented to the user with a user device 110. All responses may be recorded in a database 106 for later recall or editing. Examples of such question may include the following: (a) “Which dimensions of the classroom climate are evident in these incidents, and are they different for each incident?”; (b) “Was there any particular dimension of climate that you feel helped in these situations, and if so, why?”; (c) “Were particular dimensions more useful in one event, and less so in another? What were they, and why were they more useful?”; (d) “Looking back, do you think that a higher level of a particular dimension might have been beneficial in either event? If so, which dimension is that and why?”; (e) “Is there any reason why you might have interpreted the climate differently from your students in these events? What were those reasons, and what effect do you think they had?”; and (f) “Do you now think that there are particular dimensions that you would like to focus on? What are they?”.

Preferably after the classroom teacher has sufficiently reviewed and reflected upon her classroom climate data, the classroom teacher prioritizes particular classroom dimensions and characteristics for development by selecting option 220—“Prioritizing for Action.” The model data presented to the classroom teacher by options 216, 218 and the reflection instructions provided to the teacher provide sound preparation for assessing possible development areas.

After the classroom teacher selects option 220, the classroom teacher is preferably provided a summary of the priority data she provided for each climate dimension during her initial or subsequent review of the model data. For example, FIG. 7 is a display listing each climate dimension along with a priority assigned by the classroom teacher for each dimension. The display preferably allows the classroom teacher to change a priority (e.g., from “high” to “low” or “medium”) by means of a pull down window. The “key message,” as described in connection with FIGS. 3E and 4E is also preferably summarized for the classroom teacher in FIG. 7 for each classroom dimension. For example, the “key message” for the dimension “Fairness” corresponds to that provided to the classroom teacher in FIG. 3E, i.e., that the classroom teacher should maintain the perceived high level of Fairness in her classroom.

Option 220 also preferably provides the classroom teacher with a summary of the teacher's initial registered reaction to the feedback for each climate dimension, e.g., whether the teacher was accepting, angry, etc. FIG. 8 illustrates a chart that may be provided to the user. The chart of FIG. 8 lists each climate dimension, the teacher's indicated priority or development of each dimension, and the teacher's reaction to the feedback for the climate dimension. This chart may be provided to the classroom teacher, along with appropriate explanation, because strong negative feelings (e.g., anger, upset or disbelief) can act as a barrier to taking effective action with respect to an individual dimension. Therefore, the classroom teacher is instructed that she should not take immediate action with respect to an individual dimension unless she has fully accepted the feedback for that dimension. At this stage, the classroom teacher is provided the opportunity to modify her selected priorities and modify her indicated reactions to reflect her current feelings, such as through pull down menus.

After the classroom teacher has been provided the model data representing her classroom climate, and preferably after the classroom teacher has reflected on this data, the classroom teacher selects one or more climate dimensions to develop. This selection may be made, for example, through a screen such as is shown in FIG. 9. In FIG. 9, the classroom teacher is preferably allowed to select up to three dimensions by selecting an appropriate selectable button 902, such as with a mouse “click.” It is believed that selecting too many dimensions for development does not allow a teacher to adequately focus on development of the selected dimensions. FIG. 9 indicates that the classroom teacher has selected the Clarity dimension and the Standards dimension to develop and that both of these dimension were “high” priorities for the classroom teacher. The classroom teacher is also preferably provided the opportunity to recall her “aspirations,” which she recorded with option 204, for review from database 106. The classroom teacher is more likely to succeed if the changes she wants to make are linked to her personal and professional goals and her goals for the class.

After the classroom teacher has selected one or more dimensions to develop, an action plan is developed and provided to the classroom teacher. There are three basic phases involved with taking action to develop a climate dimension. First, the teacher should investigate how developing particular characteristics can help her address the classroom climate dimensions on which she wants to take action. Second, the teacher should develop a detailed plan for action, incorporating her ideas and reflections as described above. Third, the teacher puts her action plan into practice. The system as described herein serves as a resource and support while the teacher develops and executes her action plan.

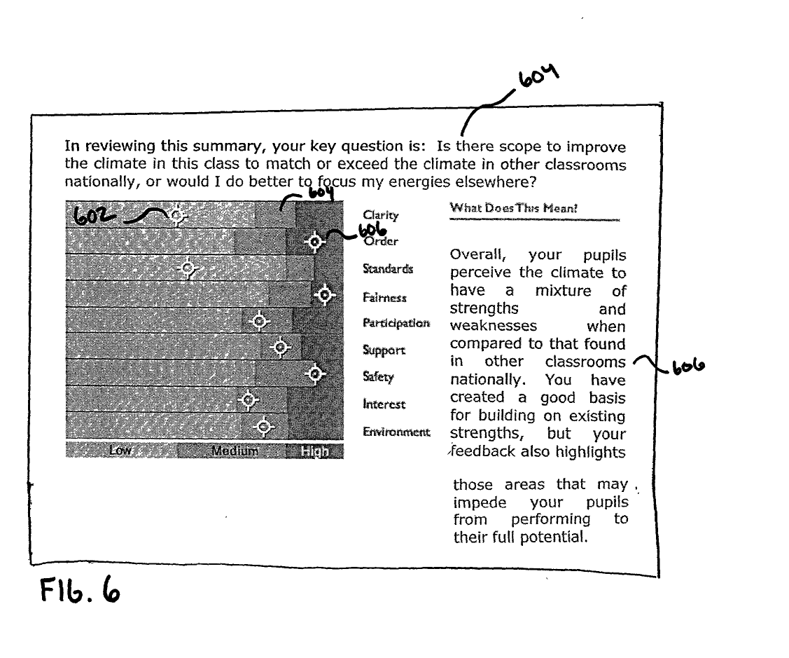

In order to create an action plan to develop one or more climate dimensions, the classroom teacher first selects one or more characteristics upon which to work. This selection may be made using option 222—“Exploring and Choosing Actions.” The classroom teacher may be presented with an interactive display, such as is shown in FIG. 10. The display lists the teacher's selected dimensions at 1002 (selected with option 220) along with a list of each characteristic at 1004 that is known to effect the dimension. These characteristics are described above. The check marks indicate which characteristic effects which dimensions. Two check marks, such as is shown next to the “Passion for Learning” characteristic, indicate that the characteristic effects both listed dimensions. Selectable buttons 1006 allow the classroom teacher to select individual teaching characteristics for action. The teacher may be allowed to select up to four characteristics for action, for example. Selection of more than four characteristics may overwhelm the teacher and impede her progress. If the teacher has already selected characteristics for action and is currently executing a developed action plan, characteristics that have been previously selected for development and that still have actions outstanding to be completed are highlighted for the classroom teacher, as shown with “Drive for Improvement”, “Holding People Accountable” and “Managing Pupils.” Selecting a characteristic name, such as by “clicking” on the characteristic, provides a link to explanatory materials on how the characteristic impacts the dimension. These materials are also available via option 212 of FIG. 2.

Once the classroom teacher has selected one or more characteristics upon which to work, the system suggests specific tasks, or action points, from database 106 that can be included in an action plan for the classroom teacher. In one exemplary embodiment, this is accomplished by initially providing the classroom teacher with a list of statements from which to choose. The classroom teacher is instructed to choose the statement that best represents the classroom teacher's view of how she feels she needs to develop the selected teaching characteristic. For example, after selecting a teaching characteristic to develop, the teacher may be asked to select one or more of the following statements: (a) “I need to understand and practice this characteristic”; (b) “I need to see the relevance and value of this characteristic”; (c) “I need to feel comfortable and achieve a sense of satisfaction when using this characteristic”; and (d) “Take no action at this time.” Once the user selects one of the statements, such as by “clicking” on the statement in a windows-type environment, one or more action points are presented to the user. For example, assuming the selected characteristic is “Passion for Learning” and the selected statement is “I need to understand and practice this characteristic,” then the following suggested action points may be presented to the user: (a) “Take some time to consider how pupils learn effectively. Read Alistair Smith's ‘Accelerated Learning in the Classroom’ to increase your understanding of different learning styles.”; (b) “Develop a plan to utilize individualized feedback that gets students to think about their understanding of a subject. Seek advice from colleagues on methods that may be effective. Practice these methods with your class and then review them at the end of each lesson.”; (c) “Arrange for a colleague to observe you with your class. Plan the observation to include gathering specific evidence of how you provide encouragement and support, your repertoire of approaches and what techniques you use to encourage learning at an individual level. Review this with your colleague and develop an action plan based upon the evidence you have gathered.”; and (d) “Consider and critically asses your methods of encouraging pupils to learn independently within and outside the classroom. Over the next three months develop a plan to increase this and review it with the class over the period.” The classroom teacher can select one or more of these activities or action points to add to an action planner (described below). The user may also be provided the opportunity to input her own action point for inclusion in her action planner, such as by describing and entering the task or plan in a textual box for saving in a database 106 and inclusion in the action plan.

If the classroom teacher selects “I need to see the relevance and value of this characteristic,” for example, possible action points for selection by the teacher may include: (a) “Think about the contrast between a teacher who is an ‘instructor’ and one who is a ‘developer of others.’ Draw up a plusses and minuses account for each. Think about the impact on your students of you adopting more of the plus points of developing others. Think about how you can compensate for some of the potential downsides. Put together a plan on this basis and talk it through with a trusted colleague”; (b) “Reflect on your experience of Passion for Learning. Sometimes teachers find it an uncomfortable process, either because they see themselves as more of a problem-solver or a pastoral carer than a learning coach, or because they see themselves as having insufficient time and perhaps experience to develop individual students fully. Reality-check your feelings with someone whose opinion you trust. Sometimes the behavior others see may be very different from how you feel inside. And remember that understanding your feelings is the first step to managing them in a truly emotionally intelligent way. Read Daniel Goleman's ‘Working With Emotional Intelligence’ for more development suggestions”; (c) “Practice using a repertoire of questions to engage students and extend their learning over the next 28 days. Review your use of this after each lesson and reflect on the difference this has made at the end of the period”; and (d) “Seek out others who successfully display a Passion for Learning and study their behavior. What do they do to achieve this? Try some of the behaviors yourself. Make sure that when you are creating your learning environment you are thinking about all your students; where possible make it colorful, active and bright.” Again, the classroom teacher is also preferably provided the opportunity to add her own action point to an action planner.

Action points may include any number of possible tasks for a classroom teacher, including, for example, reading selected items, reflecting upon particular events or concepts, practicing particular teaching styles, interviewing or observing colleagues, seeking coaching or advice from trusted colleagues, etc. Whatever the particular action or actions selected or provided by the classroom teacher for execution, these particular actions are included within an action planner customized for the teacher. The action planner may be stored in a database 106, and the system can be used to monitor and track completion of specific points or tasks in the action planner. The classroom teacher can access the action planner by selecting option 224 (FIG. 2). Developing an action plan is important to realizing significant improvement in characteristics, and consequently in a classroom dimension, and ultimately in the classroom climate as a whole.

For each action point or task selected by the classroom teacher, the classroom teacher is preferably prompted to provide a target achievement date. The classroom teacher is also preferably asked reflective questions to aid the classroom teacher in implementing each action point in her action plan. The classroom teacher can provide narrative answers to the questions, such as by typing the answer in a text window. The answers are stored in a database 106 for later retrieval and review. Examples of such questions include: (a) “What will the impact of this action be?”; (b) “What help and resources do you require?”; and (c) “How will you measure success?”.

An action plan preferably covers a finite period of time, such as a semester. The action plan may be developed towards the beginning of a semester, for example, with target achievement dates dated for sometime later in the semester. The classroom teacher can access the action plan, such as by using a user device 110 or 108, through a network 114 or 102. For each action point, the classroom teacher preferably enters a status, such as “not started,” “in progress” or “complete.” The action plan is preferably reconfigurable so that the classroom teacher can, for example, view all action points sharing the same status, such as “complete” or “in progress.”

The system also preferably provides the classroom teacher with periodic reminders of outstanding action points when the classroom teacher logs into the system. This feature may be provided to the classroom teacher through mailbox feature 226 of FIG. 2 or by electronic mail. It is also suggested that the classroom teacher review her action plan every couple of weeks or so in order to record any progress and to remind the classroom teacher of her goals and aspirations previously stated in database 106. The teacher can also re-review any of the concepts explained to the teacher in her initial review of the information provided to the classroom teacher, such as how a particular characteristic effects a classroom dimension, using option 212 or option 214.

After several months, the classroom teacher should again designate a group of students through option 206 to complete the questionnaires regarding the current climate of her classroom. The designated students may be the same students as previously designated, but they need not be as long as they represent an adequate cross-section of the class. Once these students have provided their responses to the questions and the classroom teacher has also completed her questionnaire, the classroom climate is again modeled, based in part upon this reevaluation data. This second model of the classroom climate, and its underlying dimensions, can be compared with the first set of model data to identify improvements and declines in the classroom climate. This reevaluation should help the classroom teacher evaluate her progress and reevaluate and appropriately modify her action plan.

Referring again to FIG. 2, several additional options 228-240 are shown provided to the classroom teacher at her home page for a selected class (e.g. Math 101). Option 228 (“Where I Last Left Off”) links the classroom teacher directly to the last option (204-224) completed or partially completed by the classroom teacher. Option 230 (“Questionnaire Tracker”) allows the classroom teacher to view a listing of which students designated to complete questionnaires have started or completed the questionnaires. Option 232 (“Main Home Page”) links the classroom teacher to the login screen or other home page for the system that is not customized and directed to a specific class and classroom teacher. Option 234 (“Previous Feedback Summaries”) allows the classroom teacher to pull from database 106 for review a summary of feedback for each class for which the classroom teacher has measured a classroom climate using the above described system and process.

Under the “Administration” heading of FIG. 2, option 236 allows the classroom teacher to change her password. The “Toolkit” option at 238 provides the classroom teacher links to several documents that may help the classroom teacher better understand the principles underlying the system, such as brochures, a guide to the use of the system, a slide show presentation overviewing the system, and/or a case study presentation of at least one teacher's experience with the system. Last, the “My Personal Details” option 240 allows the classroom teacher to enter and update personal information, such as email addresses, telephone numbers, full name, best time of the day to be contacted, and the like.

### Head Teacher

The same basic system and method described in connection with FIGS. 2-11 may also be utilized in connection with the development of head teacher characteristics and leadership skills. As mentioned above, a head teacher is an individual who is responsible for a school, a group of schools, a department, or a group of schools or departments, for example. The head teacher embodiment is described hereafter using the same basic framework described above in connection with FIGS. 2-11, but by illustrating specific differences in the underlying concepts and implementation between the classroom teacher and head teacher embodiments.

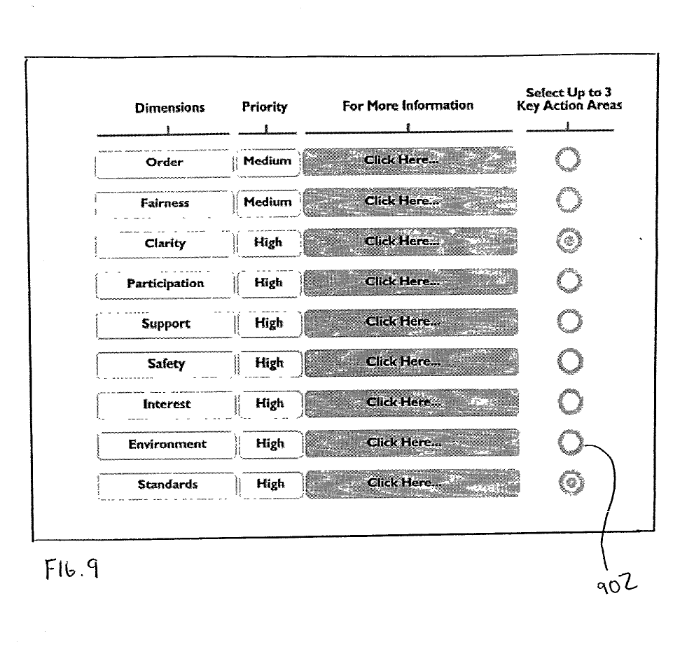

FIG. 12 illustrates an exemplary home menu screen, e.g., home page, for a head teacher who has been registered into the present system. The menu screen is similar to the classroom teacher's home page (FIG. 2) and provides similar options. In this example, “Michael” is the head teacher as indicated at 1202, and Michael's homepage is illustrated in FIG. 12. After the head teacher has established a user name and password, the head teacher can access the functionality provided by the “About You” option 1204, which provides similar functionality to the “About You” option 204 of FIG. 2 only directed to the head teacher. If the head teacher selects option 204, the head teacher is provided the option of recording her teaching and social aspirations, or if the aspirations are already recorded, to review and edit these aspirations. This information is recorded in a database 106. Once recorded, these aspirations may be revisited or modified by reselecting option 204. These aspirations are preferably recorded at the beginning of each school year or semester or the first time that the head teacher uses the system. The aspiration are also available for later editing by the head teacher, in the event that the head teacher's aspirations change.

The following are examples of questions that may be posed to a head teacher: (a) “What do you most enjoy about being a head teacher?”; (b) “What is it that makes you most proud to be a head teacher? Provide a few examples to illustrated this.”; (c) “What are your aspirations for next year? When answering this question don't limit yourself to thinking about this question in relation to work—think more broadly about your vision for the future.”; (d) “If money, health, responsibilities, longevity, etc. were not an issue, what would your ideal life look like 15 years from now?”; (e) “Ask yourself ‘What kind of person would I want to be in 15 years' time?’ (Again money, health, responsibilities, longevity are not an issue in your answer.)”; and/or (f) “If age, health, and money were not an issue, and you see yourself working in 10-15 years' time, what would you want your work to be like.”

Reflection upon one's aspirations can help in the development of head teacher characteristics and leadership skills. The information provided to this module may be presented to the head teacher in the feedback section (described below) to ensure that the head teacher's action plan (also described below) conforms to the head teacher's aspirations.

Once the head teacher has recorded his aspirations using option 1204, the head teacher is preferably provided the option of setting up his employee questionnaires through the “Questionnaire Setup” option 1206. The “Questionnaire Setup” option 1206 is very similar to the “Questionnaire Setup” option 206, but the option 1206 allows the head teacher to designate all or a cross-section of his employees to answer questions pertaining to the school, group of schools, department or groups of departments, as the case may be. Assuming the questionnaire is directed to a school environment, employees may be designated from the pool of teachers, the secretaries, the athletic coaches, the janitorial staff, etc., but should at least be an adequate cross-section of the school employees, and preferably of the teaching staff. The head teacher can also designate deadlines for the employees to respond to the questionnaire. The option 1206 also preferably provides a tracking function, whereby the head teacher can check the status of the progress of each designated employee, e.g., whether the individual employee has completed the questionnaire, has begun the questionnaire, or has not begun the questionnaire.

The questions presented to the employees and the head teacher are selected to elicit evaluation data with respect to the current condition and/or the ideal condition of the overall school climate, and particularly with respect to individual dimensions within the school climate, and to elicit evaluation data including leadership style data pertaining to the use of various leadership styles of the head teacher. The concepts underlying the classroom climate and dimensions are described below. A list of possible questions or statements that may be provided to the employees and the head teacher is set forth hereafter. The following questions 1-49 are examples of questions that may be used to elicit climate data:

1. There is not much emphasis on improving standards of performance in the school.

2. Staff in the school are not recognized in proportion to the excellence of their teaching.

3. There is an unprofessional and unsupportive atmosphere among staff in the school.

4. The policies, procedures, and standard practices set by the school make it hard to get the job done.

5. Staff are not expected to have everything checked by the head teacher if they think they have the right approach.

6. Staff in the school rarely put in extra time on the job.

7. The school's performance seldom suffers from lack of clarity of organization and direction.

8. Staff in the school are encouraged to put forward new and original ideas that will improve the quality of teaching and learning.

9. The educational vision and improvement plan for the school are unclear to the staff.

9. Staff in the school are reluctant to share resources and ideas with each other.

10. Staff in the school are not recognized for doing good work.

11. Staff in the school are reluctant to take on other people's responsibilities.

12. Staff in the school put a lot of effort into making their performance the best it can be.

13. Staff and pupils are not proud to belong to the school.

14. Staff in the school have very weak working relationships with little trust.

14. Staff in the school are discouraged from taking calculated risks.

15. Our staff promotion system helps good classroom performers rise in the school.

16. The policies and procedures in the school are clear to staff.

17. The school does not have unnecessary procedures.

18. Staff in the school do not work in an atmosphere of strong mutual respect.

19. Staff in the school will seldom go out of their way to make the quality of teaching and learning as a successful as possible.

20. Staff frequently speak well of the school.

21. Staff understand what the school's goals are.

22. The support and encouragement staff get in the school outweigh the criticism.

23. The lines of authority in the school are unclear to staff.

24. The school sets very high standards of performance for its pupils.

25. Staff in the school do not cooperate with each other.

26. The various teams in the school do not work well together to improve teaching and learning.

27. The school does not allow staff to experiment with original ideas and try out new things.

28. Mediocre staff performance is allowed to continue in the school.

29. Staff in the school are told how they should do their jobs.

30. Staff in the school are told they should do their jobs.

31. Staff in the school are cool and reserved towards each other.

32. Staff in the school are unwilling to make sacrifices to get the job done.

33. The school has a clear educational vision.

34. Salaries and allowances are generally related to things other than performance.

35. There is a lot of loyalty to the school.

36. The expectations of the school for pupil attainment are not very challenging.

37. The best way to be successful in the school is to take calculated risks.

38. The vision of the school is unclear to staff.

39. Staff in the school are not kept up to date about changes that may effect them.

40. There is a lot of gossip and backbiting in the school.

41. Staff in the school are not criticised a great deal.

42. Staff know what the school's improvement plans are.

43. Staff are rarely involved in determining the strategic plans of the school.

44. Staff frequently discuss how to improve the quality of teaching and learning in the school.

45. The school rarely monitors standards of pupil attainment against expectations.

46. The school rarely communicates its high expectations of pupils to parents.

47. The school does not set standards of performance for pupils that are appropriate to their abilities.

48. There is not a high priority on raising pupils' standards of achievement.

49. Parents are not well informed about the progress and achievements of their children.

Some questions may be more directed to identify leadership styles employed by the head teacher. The following question illustrate this point. Although the questions are phrased as directed to the head teacher, if posed to an employee, the questions are rephrased accordingly.

1. I work hard to deal with conflicts whenever they arise in my school.

2. I do not require staff to report back regularly about their activities, either in writing or orally.

3. I try to reduce resistance to my decision by informing staff what they have to gain.

4. To lead the staff, I talk in detail with them about how things could be done.

5. I spend a lot of time reviewing individual staff progress both directly and indirectly, to determine what developments are necessary.

6. I often delegate important management tasks to staff.

7. I do not develop close personal relationships with staff.

8. When staff fail at a tasks, I calmly but firmly let them know why.

9. As long as I see results, I do not get involved in the staff's work.

10. I let staff find out for themselves opportunities for their professional development.

11. I keep everyone involved and well-informed about school organizational issues that may effect them.

12. I discourage activities that might lead to conflict among staff.

13. I rarely give direction in the form of a suggestion.

14. I allow staff to make most of their own decisions.

15. I frequently monitor staff to see how they are progressing with particular projects.

16. When there are any controversial changes in the school, I simply announce them without prior discussion with the staff.

17. 1 encourage staff to talk to me about personal problems.

18. I praise staff only for outstanding work.

19. I believe that getting the job done is more important than the staff's feelings.

20. I make a special effort to explain to staff the purpose of new developments or policy initiatives.

21. I let staff find ways to complete their tasks themselves.

22. When a staff member's work begins to fall short, I reallocate or take over the task myself.

23. I do not monitor staff very closely, either directly or indirectly, unless there are specific problems with their work.

24. I keep meetings with staff to the minimum needed to get the job done.

25. I expect staff to follow my instructions precisely.

26. When staff disagree with me, I explain why I want something done a certain way.

27. I do not put much effort into developing staff professionally.

28. I do not believe I need much personal contact with staff to use each person's talent most effectively.

29. I show staff the best ways to implement new initiatives.

30. I believe that when staff know what has to be done, specific targets/guidelines for school improvement are unnecessary.

31. I use the authority of my position to influence staff.

32. If staff's goals seem reasonable, I do not ask questions about them.

33. I give capable staff the freedom to make decisions and mistakes without close supervision.

34. I do not always expect staff to comply with my instructions immediately.

35. I devote a great deal of time to considering staff job security and rewards.

36. I will spend whatever time is needed to improve poor teachers.

37. I take time to explain the reasons for decisions, in terms of the best interests of the school and my staff.

38. I rarely demonstrate personal concern for the well being of staff.

39. In making decisions, I trust my own judgement and do not seek input from staff.

40. After introducing new staff I let them make friends on their own.

41. Helping staff to improve their professional performances is a very small amount of my time.

42 I assume staff will complete their tasks without frequent monitoring.

43. I only praise superior standards of pupil achievement and quality of teaching and learning.

44. I motivate staff by letting them know the negative consequences if their work is unsatisfactory.

45. I almost always tell staff when they have done good work.

46. I do not allow staff to participate in managerial decision making.

Responses may be provided on a rated scale and questions may be posed in both the affirmative and negative. One exemplary method of posing questions to both the employees and head teacher is in accordance with the method described in connection with FIG. 11 for the classroom teacher embodiment. Also, as described in connection with FIG. 2 and option 210, the head teacher can access the questionnaires in order to provide his responses through option 1210 (“The Questionnaires”) of FIG. 12.

The “Understanding the Concepts” option 1212 provides the head teacher with information identifying how the system may be used to help the head teacher improve his head teacher characteristics and leadership skills, and thereby enhance the overall school climate and the students' education. The conceptual framework upon which the system is founded is also described via option 1212. The head teacher is encouraged by the text provided to the head teacher after selecting option 1212 to take the necessary time to fully understand these concepts prior to receiving any feedback from the system. These concepts are described hereafter, with particular features of an exemplary option 1212 described therewith.

The advice and feedback provided by the system is preferably focused on improving the head teacher's capabilities in those areas that have a direct impact on the performance of the school. Extensive research by the assignee and the United Kingdom have identified four primary factors related to the head teacher that contribute to a school's performance. First “job demands”—the demands and expectations placed on a head teacher set the framework for improving school performance. In particular, the job demands define the characteristics a head teacher must have. Second, “head teacher characteristics” are those behaviors that outstanding head teachers display to a greater extent than average head teachers. These characteristics incline a head teacher towards adopting particular “leadership styles” more frequently or in a wider variety of situations than others. “Leadership style”—the way a head teacher is perceived to lead a school—accounts for up to 70% of any particular Context for School Improvement in a school. Last, the Context for School Improvement is the school climate, i.e., what it feels like currently to work in the head teacher's school—the staff's current impressions, expectations and feelings. This school climate has a direct impact on school performance. Research has shown that up to 30% of the difference in school performance can be explained by this school climate.

One of the most important factors in determining performance in schools is the match between the ongoing demands of the job of a head teacher and the behavioral characteristics of the head teacher. To drive improvements, the head teacher must develop the characteristics that allow the head teacher to fulfil the job demands. There is no single best characteristic for a head teacher or for any other job. However, research has shown that there are best combinations, any one of which can achieve outstanding results.

For example, the research discussed above has revealed a “Models of Excellence for Head Teachers” that describe fifteen characteristics that combine to deliver highly effective head teacher performance. These characteristics can be grouped into five clusters. To achieve results, head teachers should strongly exhibit one or more characteristics from each cluster.

A first cluster may be characterized as “Personal Values and Passionate Conviction” and recognizes that highly effective head teachers enact a strongly-held set of values. This cluster includes three characteristics: (1) respect for others; (2) challenge and support; and (3) personal conviction. “Respect for others” is the characteristic of demonstrating that other people matter and deserve respect. This includes prioritizing, listening to, and valuing both pupils and staff, even when they do not agree with a head teacher's views. “Challenge and support” is the characteristic of creating a genuinely supportive environment and doing everything possible to help pupils succeed, including showing determination and challenging or confronting when necessary. “Personal conviction” is the characteristic of acting in accordance with a passionate commitment to education and helping others to act likewise, even when it is difficult to do so.

A second cluster may be characterized as “Creating a Vision.” Highly effective head teachers create a vision for the school that focuses on performance improvement. A first characteristic under this cluster is “strategic thinking.” This is the characteristic of recognizing relevant patterns in a complex, highly detailed environments and making sense of links and influences within and outside of the school. This includes thinking creatively to solve problems or issues. A second characteristic is “drive for improvement”—the characteristic of setting challenging targets for pupils and the school and doing everything that needs to be done to meet those goals.

A third cluster may be characterized as “Planning, Monitoring and Improving.” Highly effective head teachers make plans to realize their vision, monitor progress towards the plans and take timely action to address problems or realize opportunities. In doing so, they work with and through others to make improvements. This cluster includes six characteristics: (1) analytical thinking; (2) initiative; (3) transformational leadership; (4) teamworking; (5) understanding others; and (6) developing potential. “Analytical thinking” is the ability to think logically and analytically to prioritize key issues and determine causes and effects. “Initiative” is the ability to take decisive and immediate action to solve or preempt problems. “Transformational leadership” recognizes the ability to focus as a leader to drive improvement and innovation. This includes enthusing others to work together and provide clear direction and support. “Teamworking” is the ability to collaborate with others to achieve shared goals. The characteristic of understanding others recognizes the ability to take time and trouble to understand others, their points of view and why they act the way they do. Finally, the characteristic of “developing potential” is the ability to make opportunities to develop others' capabilities and help them improve their performance. This includes delegating and nurturing positive expectations.

The fourth cluster—“Building Commitment and Support”—recognizes that highly effective head teachers use their influence to win support for the benefit of the school, or take firm action when appropriate to secure the performance of others. This cluster includes two head teacher characteristics: (1) impact and influence and (2) holding people accountable. The characteristic of “impact and influence” is the ability to impress and influence others to achieve positive outcomes for pupils and the school. This includes gaining commitment and bringing together diverse groups. The characteristic of “holding people accountable” is the ability to make accountability clear and to hold people to task. This includes taking action to challenge complacency and embed new expectations and values.

The fifth cluster—“Gathering Information and Gaining Understanding”—recognizes that highly effective head teachers gather both hard information (e.g., statistical data and the like) and soft information (e.g., information gleaned from personal contacts and interviews) that they use to set appropriate school goals and an appropriate strategy for achieving those goals. A first characteristic in this cluster is “understanding the environment,” i.e., appreciating and making positive use of the different ways in which people can and do relate to one another and contribute to the school. A second characteristic is “information seeking”—finding out more about people or issues that matter and getting to the heart of matters.

Research has shown that a head teacher's leadership style can account for up to 70% of the school climate. The school climate, in turn, can account for up to 30% of pupil performance. Leadership style is the way that a head teacher is perceived by his colleagues to lead a school. Research has identified six distinct leadership styles: (a) coercive; (b) authoritative; (c) affiliative; (d) democratic; (e) pacesetting; and (f) coaching. There is no one right or wrong leadership style. The most effective style, or combination of styles, depends on and varies according to the task, the people involved and the situation. Effective head teachers have the ability to diagnose the demands of the situation and to draw from a wide range of leadership styles, rather than overly relying on one or two styles to deal with all situations. An overview of each leadership style is provided hereafter.

A head teacher that demonstrates the “coercive” style gives a lot of directive rather than direction and does not permit much staff input. The primary objective of the style is immediate compliance. The head teacher expects immediate staff compliance and controls tightly through close monitoring. This head teacher relies on negative, corrective feedback to emphasize what is being done wrong and sometimes uses attention-getting strategies, such as ridicule, to embarrass a member of the staff into compliance. Further, the head teacher that demonstrates this leadership style motivates by stating the negative consequences of non-compliance rather than by rewarding compliance.

The coercive style is most effective when: (1) applied to relatively straight forward tasks; (2) used in crisis situations; (3) deviations from policies and procedures will result in serious problems; and (4) all else has failed with underperforming or problem employees or students. The coercive style is least effective: (1) when applied to tasks that are not straightforward—the more complex the tasks, the more ineffective this style becomes, possibly provoking rebellion; (2) over the long-term, because staff are not being developed and tend to rebel, resist passively or leave; and (3) in extended interactions with self-motivated staff capable of directing and monitoring their own work, with talented, knowledgeable staff expected to initiate or innovate, and with individual specialists.

The primary objective of the “authoritative” style is long-term direction and vision for staff. The head teacher utilizing this style articulates a clear vision and takes responsibility for developing and articulating a clear vision and direction for the school. The head teacher solicits staff perspective on the vision and/or on the best way to achieve the vision, while not surrendering authority. The head teacher views selling the vision or direction as a key part of the head teacher's job and persuades staff by explaining the rationale behind the vision in terms of the staff's or the school's long-range best interests. A head teacher exhibiting this style sets standards and monitors performance in relation to the larger vision and uses a balance of positive and negative feedback to enhance motivation.

The authoritative style is most effective when: (1) a new vision or clear direction and standards are needed; (2) the head teacher is perceived to be the expert; and (3) new members of the team or people undertaking new tasks depend on the head teacher for active guidance. The authoritative style is least effective when: (1) the head teacher does not develop staff such that they feel stifled and do not take initiative; (2) the head teacher is not perceived as credible, or if used extensively with sophisticated and experience staff who know as much or more than the head teacher; and (3) trying to promote self-managed work teams and participatory decision-making.

The primary objective of the “affiliative” style is creating harmony among staff and between leaders and staff, i.e., to avoid conflict. When using this style, the head teacher is most concerned with promoting friendly interactions among staff and places less emphasis on tasks directions, goals and standards than on meeting the staff's emotional needs. The head teacher pays attention to and cares for the whole person and stresses things that keep people happy, such as job security, fringe benefits and family-job tradeoffs. The head teacher identifies opportunities for positive feedback and avoids performance-related confrontations as well as rewards personal characteristics, sometimes as much as job performance.

The affiliative style is most effective when: (1) used as part of a repertoire that includes authoritative, democratic or coaching styles; (2) there is a lot of interpersonal conflict within the school; (3) giving personal help to others; and (4) getting diverse or conflicting groups of individuals to work in harmony. The affiliative style is least effective: (1) when staff's performance is inadequate and negative performance feedback is forthcoming for improvement; (2) in crisis or complex situations requiring direction and control; and (3) with staff who are task-focused and uninterested in friendship with the head teacher.

The primary objective of the “democratic” style is to build commitment among staff by consensus and to generate new ideas. It also means making decisions by consensus. When using this style, the head teacher trusts that staff have the capability to develop the appropriate direction for themselves and the school. The head teacher invites the staff to make decisions effecting their work and reaches decisions by consensus. The head teacher holds many meetings and listens to staff's concerns while rewarding adequate performance and rarely giving negative feedback or punishment.

The democratic style is most effective when (1) team members are competent; (2) team members possess critical information; (3) other members have clearer ideas about the best approach; and (4) the authoritative style has already been used to create and champion a vision. The democratic style is least effective in crises when there is no time to hold meetings and when staff are incompetent, lack crucial information, or need close supervision.

The “pacesetting” style's primary focus is immediate task accomplishment to a high level of excellence. When using this style, a head teacher leads by example and has high standards and expects others to know the principles and rationale behind the strategy being followed. A head teacher exhibiting the pacesetting styles is apprehensive about delegating a task without assurance that the person can do the task to the high standard. The head teacher takes responsibility for tasks away from a staff member if the performance is not forthcoming. The head teacher has little sympathy for poor performance and rescues the situation or urgently gives detailed task instructions when staff experience difficulties and ask for help. The head teacher thereby fails to develop his staff and sees coordination with others only as it has an impact on the immediate task.

The pacesetting style is most effective when: (1) team members are highly motivated, competent, know their jobs and need little direction; (2) quick results are required; and (3) acting as a role model to develop a similar team member. The style is least effective when: (1) the head teacher cannot do all his or her work personally and requires increased delegation; and (2) when staff need direction, development and coordination.

Last, the primary objective of the “coaching” leadership style is long-term development of others, versus the pacesetting style, which focuses on immediate task accomplishment. Use of this style helps individuals identify their unique strengths and weaknesses. It requires sitting down and having a candid, mutual conversation with staff about those strengths and weaknesses in light of their aspirations. When using this style, the head teacher helps members of the staff identify their unique strengths and weaknesses in the light of their aspirations and encourages members to establish long-range development goals. The head teacher reaches agreement with staff on both the head teacher's and the staff's roles in the development process. The head teacher may tradeoff immediate standards of performance for long-term development.

The coaching style is most effective when: (1) staff or students acknowledge a discrepancy between their current level of performance and where they would like to be; (2) giving behavioral feedback to others to improve performance; and (3) supporting team members in their professional development. The style is least effective when the head teacher lacks experience of the particular situation and the staff require much direction and feedback in a crisis.

Below is a chart indicating which head teacher characteristics or competencies have the most statistically significant effect on the leadership styles just described:

| Competency/ | Coercive | Authoritative | Affiliative | Democratic | Pacesetting | Coaching |
|---|---|---|---|---|---|---|
| Characteristic | Style | Style | Style | Styles | Style | Style |
| Strategic | | ✓ | | | | |
| Thinking | | | | | | |
| Impact and | ✓ | ✓ | | | ✓ | |
| Influence | | | | | | |
| Drive for | | | | | ✓ | |
| Improvement | | | | | | |
| Personal | | ✓ | | | ✓ | |
| Conviction | | | | | | |
| Transformational | | ✓ | | ✓ | | |
| Leadership | | | | | | |
| Holding People | ✓ | | | ✓ | | |
| Accountable | | | | | | |
| Initiative | | | | | | |
| Understanding | | | ✓ | | | |
| the Enviromnent | | | | | | |
| Analytical | ✓ | | | | ✓ | |
| Thinking | | | | | | |
| Developing | | | | | | ✓ |
| Potential | | | | | | |
| Teamworking | | | ✓ | ✓ | | |
| Respect for | | | ✓ | ✓ | | ✓ |
| Others | | | | | | |
| Challenge and | | | | | | ✓ |
| Support | | | | | | |
| Understanding | ✓ | | ✓ | | | ✓ |
| Others | | | | | | |
| Information | | | | | | |
| Seeking | | | | | | |

Each leadership style is associated with the four most characteristics that most significantly effect the particular style. The chart shows that “Initiative” and “Information Seeking” are not among the four most significant characteristics for any of the six listed leadership styles.

In addition to explaining these leadership style concepts to the head teacher, the option 1212 also preferably provides examples of each leadership style in practice.

The concept of the Context for School Improvement or school climate is described below. The atmosphere within a school makes a difference to school achievement standards and school improvement, or lack thereof. It influences the extent to which individuals feel motivated to perform at higher levels. Evaluating the dimensions that make up the school climate reveal how energizing it is to be a part of the school community and indicate how well the school is realizing its full potential. Schools that systematically evaluate the climate and address any shortcomings can tap the full potential of their teachers, support staff and students and see standards of achievement rise.

The school climate indicates the perception of how it feels to be a staff member or student in a particular school. It is the school atmosphere, including a mix of norms, values, expectations, policies and procedures that influence individual and group patterns of behavior. The research has shown that several key dimensions collectively make up this school climate: (1) flexibility; (2) responsibility; (3) standards; (4) reward; (5) clarity; and (6) team commitment. Each of the six contextual dimensions is important in creating a positive school atmosphere for improving standards of performance. Improving this climate is also linked to the development of a repertoire of head teacher leadership style, which are effected by the characteristics described above.

The climate dimension “flexibility” represents the degree to which staff feel there are no unnecessary procedures, policies and practices that interfere with task accomplishment and that new ideas are encouraged. When flexibility is high, staff feel that there are no unnecessary procedures, policies or practices that interfere with job performance. They also feel that new ideas are encouraged.

“Responsibility” represents the degree to which staff feel that they can do their jobs without having to check everything with their boss and the extent to which they feel encouraged to take calculated risks. When responsibility is high, staff feel that they can manage their work without having to check everything with their manager. The staff feel encouraged to take calculated risks.

The “standards” dimension represents the extent to which staff think management emphasizes improving performance by doing such things as setting challenging but attainable goals for staff and the school as a whole. When standards are high, staff feel that school management emphasizes ongoing performance improvements. They observe this through such things as the setting of challenging but attainable goals for the staff and for the school as a whole.

The “reward” dimension identifies the degree to which staff feel they are being recognized for good work and that such recognition is directly and differentially related to levels of performance. When the reward dimension is high, staff feel that they are recognized and praised for good work and that such recognition is directly and differentially related to their levels of performance.

The “clarity” dimension measures the degree to which staff feel that everyone knows what is expected of them and that they understand how these expectations relate to the larger goals of the school. When clarity is high, staff fell that they know what is expected of them. They understand how these expectations relate to the larger goals of the school.

Finally, the “team commitment” dimension represents the feeling that people are proud to belong to the school, will provide extra effort when needed, and trust that everyone is working toward a common objective. When team commitment is high, staff feel proud to belong to the school and are willing to provide the extra effort needed, as well as trust that everyone is working toward a common objective.

In addition to explaining these dimensional concepts to the head teacher, the option 1212 also preferably provides examples of each dimension in practice, such as through hypothetical examples.

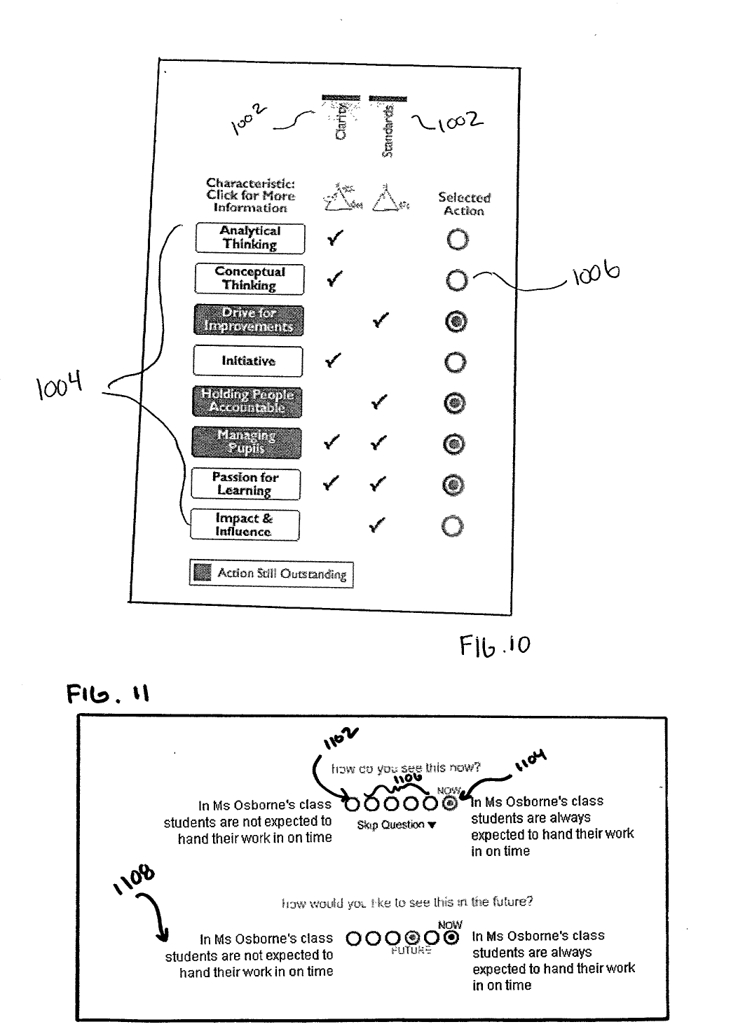

As mentioned, each of the above-described dimensions is directly impacted by the use of leadership styles. Particular dimensions of the school climate are driven by particular styles. For example, to increase the clarity dimension, the authoritative style and the coaching style are key leadership styles. FIG. 13 is a table illustrating, based upon research, the relative value or importance of each leadership style to the six dimensions described above.

After the head teacher has been introduced to the concepts that underlie the system, the head teacher is preferably provided the opportunity to apply his understanding of the concepts to real-life scenarios. This opportunity may be provided in the form of case studies. The head teacher is provided a case study for review and is then asked to identify the dominant school climate dimension or dimensions from the case study. The head teacher is also preferably asked to identify the leadership style being used by the head teacher in the case study.

Option 1214—“About Your Context”—prompts the head teacher to record two personal incidents, similar to Option 214 of the classroom teacher embodiment. The personal incidents preferably each involve situations where the head teacher was managing or leading people to raise standards of achievement in the school. The head teacher preferably provides an incident where the head teacher feels he was effective and one incident where the head teacher feels he was less effective. Reflecting upon these incidents helps the head teacher identify the context in which he is working, how the head teacher applies different leadership styles, and the impact the head teacher has upon the Context for School Improvement, i.e., the school climate. This reflection helps the head teacher interpret and digest the feedback provided by the head teacher's employees. For each incident, the head teacher is preferably asked to provide answers to questions that help the teacher reflect upon the incident or better recall the incident. Examples may include: “Who was involved?”; “What did you think, feel and want to do?”; “What did you say or do?”; and “What happened.” Option 1214 also provides the head teacher the opportunity to later review these responses and edit them if desired. These responses are also preferably made available to the head teacher during feedback and action planning, as described below, in order to help the head teacher consider the feedback and provide further reflective evidence for action planning.

Option 1214 also preferably provides guidance to the head teacher on how to process the feedback provided to the head teacher by the system. For example, the option may explain to the head teacher that there are five general possible reactions to feedback: (1) accepting; (2) reflecting; (3) upset; (4) angry; and (5) disbelief. If the head teacher is “accepting” of the feedback, he is ready to use the feedback to develop an action plan (described below). If the head teacher is still “reflective,” the option preferably advises the head teacher to begin by accepting the feedback as genuine evaluations of how the employees perceive the school environment. The head teacher may be advised to re-review the material provided by the Understanding the Concepts option 1212. The head teacher should also review his goals and aspirations provided in option 1204 as well as any response provided to the feedback through option 1216 and 1222 (described below). Option 1214 may also advise the head teacher to take some time away from reflecting on the feedback if the head teacher is “upset” or to discuss the feedback with a sympathetic colleague who will also speak frankly to the head teacher. If the head teacher is “angry,” the head teacher should also take some time away from reflecting on the feedback. Last, if the head teacher is in “disbelief,” the head teacher, or a trusted colleague, should play devil's advocate in order to help the head teacher digest the feedback. The head teacher should also take time to re-review the concepts explained by the Understanding the Concepts option 1212 so that the head teacher clearly understands exactly what the feedback is and is not saying.

The option 1214 also preferably explains to the head teacher that the feedback or evaluation data provided by the employees is most helpful when the head teacher clearly understands the feedback, accepts the feedback and can do something about the feedback. The head teacher can best understand the feedback by understanding the underlying concepts of the school climate as described above. The head teacher can learn to accept the feedback by clearly understanding the concepts, taking time to reflect on the feedback, and discussing the feedback with trusted colleagues, for example. Last, the head teacher may be provided advice on prioritizing areas upon which to work such that the head teacher can respond to the feedback with an action plan that allows the head teacher to improve the school climate. For example, the head teacher may be advised to explore the feedback to decide what messages the staff have given that indicate the most important areas for improvement. The head teacher should be realistic but optimistic because changing people's perceptions can take some effort; but dramatic changes can be achieved over a relatively short period of time. Also, if the feedback indicates a relatively strong school climate, with only limited scope for improvement, the head teacher should take action on other key issues, such as considering helping sister schools with their climates.

The About Your Context option 1214 also preferably provides narrative and examples to the head teacher that explain how the evaluation data provided by the head teacher and the employees through the questionnaires is going to be illustrated to the head teacher. This helps the head teacher concentrate on the key message of the data during the feedback process described below rather than struggle to make sense of how the evaluation data are being provided. The presentation of this data is described in more detail below, but generally, the data are preferably provided as a series of charts, tables, graphics or the like, each with some personalized explanatory text to help the head teacher interpret the data and with options for exploring what the feedback might mean in practical terms.

There are two primary parts to receiving feedback. The first part is receiving model data for the school climate. This model data are preferably presented in chart format, one dimension at a time, followed by summary charts. The second part is receiving model data including leadership style evaluation data. This data are preferably provided for all of the leadership styles at once in the form of a series of tables. The head teacher is also provided the opportunity to select key dimension areas for action and at least one leadership style to develop in order to impact each selected dimension.

After all of the nominated employees have completed their respective questionnaires via the system and the head teacher has completed his questionnaires, and preferably after the head teacher has thoroughly reviewed the material provided by the “Understanding The Concepts” option 1212 and “About Your Context” option 1214, the head teacher selects the “CSI Detailed Feedback” option 1216. Before the evaluation data provided by the employees and the head teacher are made available through option 1216, the data may be checked to ensure their quality. For example, the system may verify that sufficient questions have been answered to provide sufficient data relevant to each dimension and each leadership style. It may also be verified that no one has misunderstood the questionnaire. For instance, an employee may have used the same end of a scale for all of his responses, even though some questions are reversed in relation to others. There may also be a check conducted to verify that sufficient data are available such that the individual responses of any particular colleague cannot be identified.

Also, prior to selecting option 1216 to review the evaluation data, the head teacher should take a few moments to review his aspirations and goals provided via, and reviewable through, option 1204. It may prove helpful to the head teacher to review the evaluation data in light of what the head teacher hopes to achieve and what is important to the head teacher personally and professionally.

Through option 1216, school climate feedback is provided to the classroom teacher, including model data, that represents one or more classroom dimensions (e.g., flexibility, responsibility, standards, clarity, team commitment, and reward). The model data preferably illustrate the following for each dimension: (1) the gap between how the head teacher believes the employees currently perceive the climate to be in the school and how the head teacher thinks they would ideally like the climate to be like in the future; (2) the difference between the head teacher's perception and the employees' perceptions of the current school climate; (3) the gap between the employees' perceptions of the current school climate and how they would like the climate to be like in the future; and (4) the difference between the employees' perception of the current school climate and a community benchmark experience of school climates, such as on national or local level. Of course, other combinations may also be utilized, such as: (1) the gap between the perception of the employees of the current school climate and what the head teacher thinks they would like the climate to be in the future; (2) a difference between the head teacher's perceptions of the current climate and an indication from the employees of what they would like the climate to be in the future; and (3) a difference between what the head teacher thinks the employees would like the climate to be in the future and an indication of what the employees would like the climate to be like in the future.

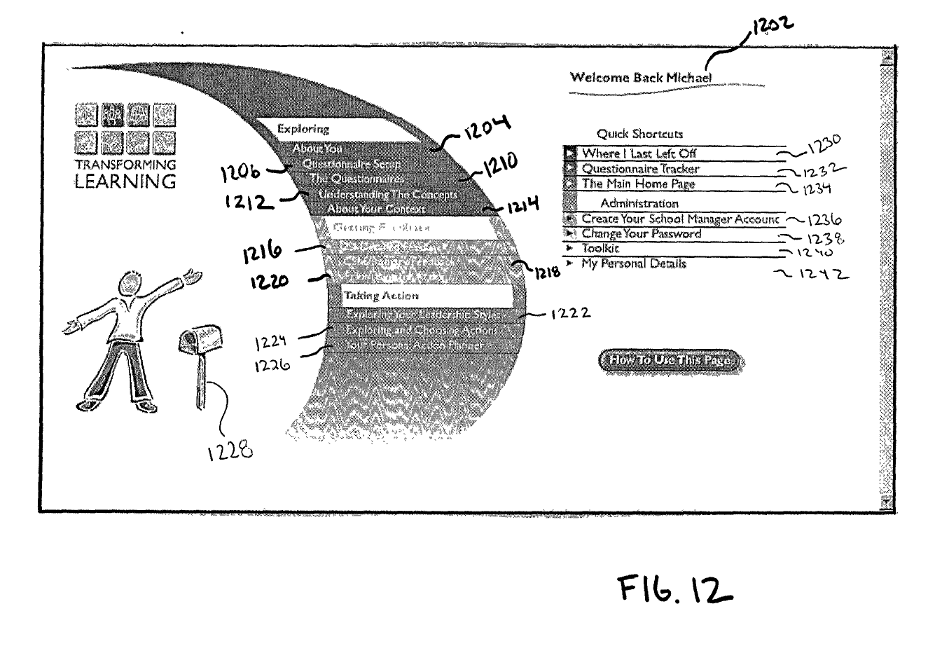

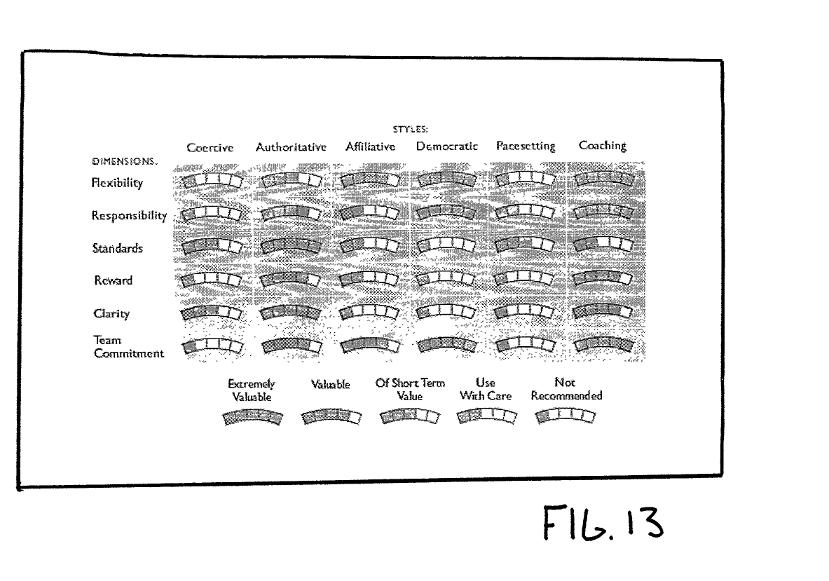

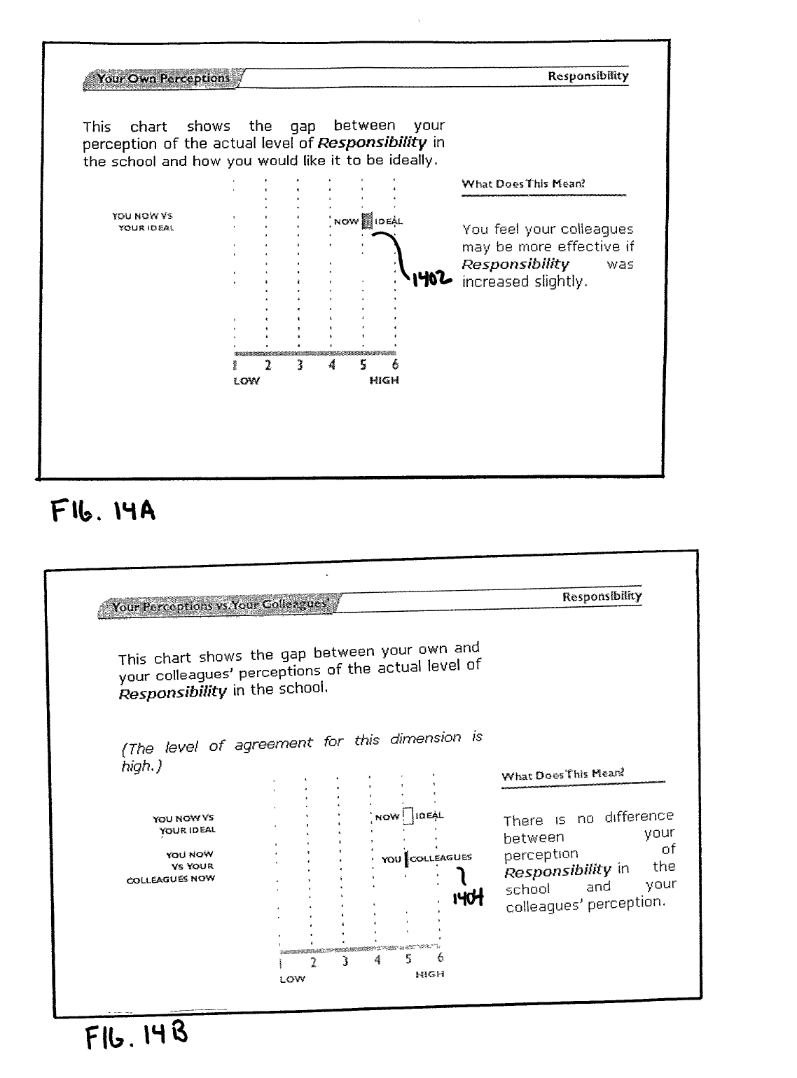

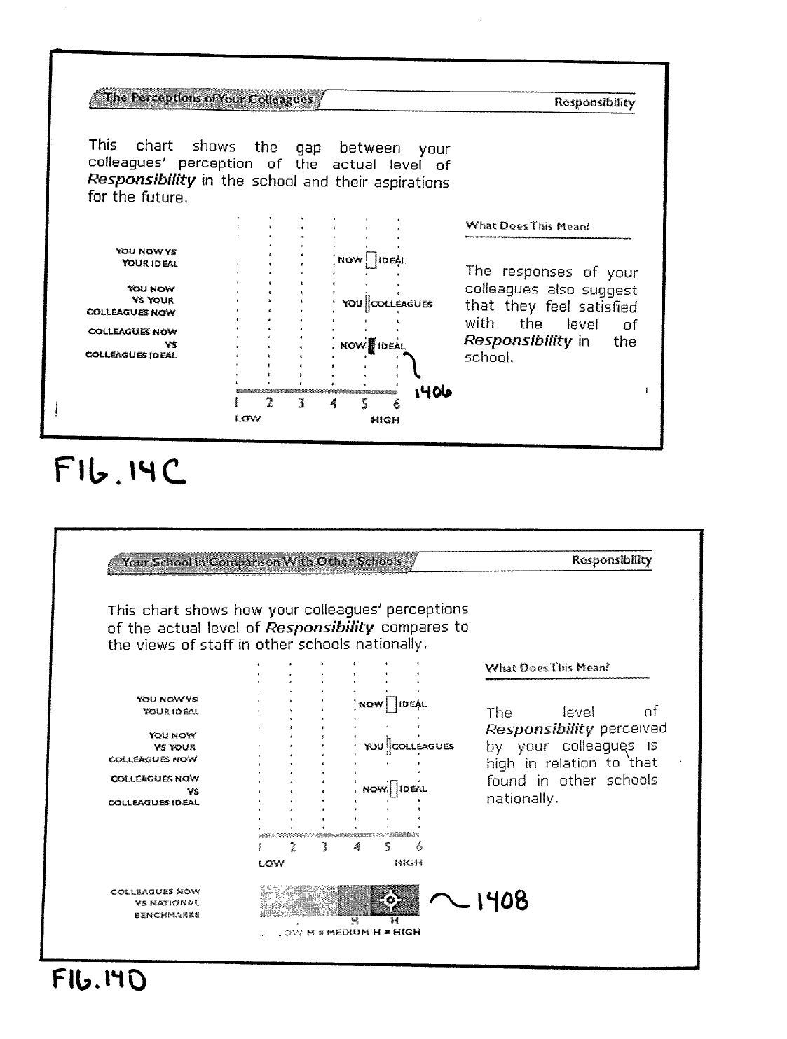

The model data representing one or more of the dimensions of the classroom climate and generated at least in part from the evaluation data received from the designated employees and the head teacher are preferably, although not necessarily, provided to the head teacher in a graphical format displayed to the head teacher on a monitor or other display of a user device 110 or 108. FIGS. 14A through 14E illustrate model data for the school climate dimension “Responsibility.” It should be understood that similar model data may be provided for each school dimension and that other manners of providing the model data are also appropriate, e.g., by different graphical methods or in a purely textual or numerical format.

Referring first to FIG. 14A, a combined chart and textual display of model data for the dimension “Responsibility” is shown. At 1402, the gap between the head teacher's perception of the actual level of the climate dimension in the school and what the head teacher would like that perception to be ideally is shown. This gap is also expressed textually in an interpretation displayed to the head teacher: “You feel your colleagues may be more effective if Responsibility was increased slightly.”

FIG. 14B indicates at 1404 the gap between the head teacher's and the employees' perceptions of the current or actual level of the climate dimension Responsibility in the school. The narrow gap at 1404 indicates that there is not much difference between the head teacher's and the employees' perception of the actual level of this climate dimension. Again, these data may also be displayed to the head teacher in a textual format, as shown in FIG. 14B: “There is no difference between your perception of Responsibility in the school and your colleagues' perception.”; and “The level of agreement for this dimension is high.”

FIG. 14C indicates the gap between the employees' current perception of the climate dimension Responsibility and their ideal level for this dimension at 1406. The gap is relatively small and the current state of responsibility is between “5” and “6” out of a total of “6.” The display, therefore, also indicates textually that, “The responses of your colleagues suggest that they feel satisfied with the level of Responsibility in the school.”

A comparison between the employees' perception of the current state of the climate dimension Responsibility in the school and a community benchmark such as a national or regional benchmark is shown at 1408 of FIG. 14D. As mentioned above in connection with FIG. 6, “low,” “medium” and “high” can represent percentile ranges. FIG. 14D indicates both textually and at 1408 that the level of the climate dimension Responsibility perceived by employees at the school is relatively high in relation to that perceived by employees in others schools nationally. This national data, for both the classroom teacher and head teacher, can be based on surveys or by compiling evaluation data from several schools using the present system.

Once the data of FIGS. 14A-14D are provided to the head teacher, the system preferably provides a summary display that provides the head teacher with a “key message” to be discerned from the data. An example of such a display is provided in FIG. 14E. FIG. 14E includes a display of the graphical dimension information provided in FIGS. 14A-14D and a textual summary of the key message that is provided by the data: “You are in tune with the perceptions of your colleagues about Responsibility, and the level of this dimension is high in relation to that in other schools nationally. The challenge for you is to maintain this, whilst developing the most significant finding in your feedback highlighted below.” The “key message” may be determined by an algorithm as described in connection with the classroom teacher embodiment. The determination of whether relative gaps, as shown for example in FIGS. 4A-4D, are significant or insignificant, or large or small, is determined based upon research as to what constitutes significant or large discrepancies in this type of data. The size of these relative gaps can be compared against a table of predefined textual interpretations, each being associated with a respective gap size, so that the textual interpretations may be displayed along with the chart. Of course, one of ordinary skill should recognize that whether the data identify a significant or insignificant or large or small gap or discrepancy in perception is subject to interpretation. However, the underlying concept is the same, i.e., the dimension model data may be presented to the head teacher in some manner along with an interpretation that may be helpful to the head teacher in determining the head teacher's priorities with respect to the dimension and any actions that should be taken.

Like the classroom teacher embodiment described above, once the head teacher has reviewed the model data for an individual school dimension, the system preferably prompts the head teacher to register his feelings about the information he has been provided with respect to that dimension. For example, the head teacher may be prompted to select a statement that best summarizes his feelings, e.g., accepting, reflecting, upset, angry, or disbelief. After the head teacher registers his feelings, the head teacher may respond with narrative responses to reflective questions regarding the dimension. The narrative responses may be typed into a data entry “window” for example for transmittal to and storage in a data storage unit 106. This is particular helpful when the head teacher is angry or disbelieves the model data. The head teacher may be presented with reflective questions, such as: “What could you do differently to gain a better insight into how your colleagues perceive the level of (insert dimension) within the school?”; “What might underpin the aspirations of your colleagues for the level of (insert dimension) they need? How might you respond to these aspirations, and what are the implications of doing so?”; What is there about your school, your staff or your approach as a head teacher that might explain any difference between the level of (insert dimension) in the school compared with the level in other schools nationally? How might your respond to this difference in views, and what are the implications of doing so?“.

Last, for each dimension, the head teacher is prompted to provide an initial priority level for the development of the dimension. For example, the head teacher may be prompted to provide whether he feels development of the dimension is a low, medium or high level of priority. All responses to the model data provided by the head teacher are stored in database 106 for retrieval and later use. This review and response process is preferably repeated by the head teacher until model data for each classroom dimension is reviewed by the head teacher.

In addition to reviewing the climate dimension model data with option 1216, the head teacher can review summaries of the model data by selecting CSI Summary Feedback option 1218. Similar to FIG. 5 and option 218 in the classroom teacher embodiment, when the head teacher selects option 1218, the head teacher is provided a display that models the school climate as a comparison between the six dimensions with respect to the relative gap between the head teacher's perception of each individual dimension and that of the employees. For example, for the six dimensions set forth above, a chart may be used to illustrate the relative size of the gap for each dimension, whether the gap is relatively small, medium or large, and whether a respective gap indicates that the head teacher thinks the climate dimension is higher than do the employees, or vice versa. Such a chart may help the head teacher identify areas in the climate where there are particular differences in perception and where, therefore, the head teacher might focus his priorities for action. Like FIG. 5, the information provided to the head teacher in the chart is also preferably summarized for the head teacher in narrative form. For example, an absence of any large gaps between the head teacher's perception and that of the employees for any climate dimension, and the presence of only a couple of medium gaps, may indicate that, in general, the head teacher has a fair perception of the climate and a strong basis for identifying areas for priority. Of course, a determination from information provided to a head teacher as to whether the head teacher has a fair understanding of the climate is made based upon a predefined algorithm, but guided by the research that supports the modeling of a school climate into the six aforementioned dimensions. Also, the determination of whether a gap is small, medium or large is also relative and is guided by the research.

Like FIG. 6 of the classroom teacher embodiment, the head teacher embodiment through option 1218 may also provide the head teacher with a chart that provides model data that further summarize the school climate dimensions as a gap between the actual level of each school climate dimension and the level of each dimension in other schools, such as on a national average. This feedback may help the head teacher identify areas of the climate where the head teacher's colleagues perceive particular strengths within the school or where there are particular concerns among the employees, compared to other schools. Further, like FIG. 6, a textual summary of the chart may accompany the chart. As mentioned above, such narrative analysis may be provided from a database 106 of narrative analysis, as selectively recalled based upon an appropriate algorithm.

As described above in connection with the classroom teacher embodiment and in connection with the model data provided to the head teacher for each individual dimension of the school climate, the head teacher is also preferably prompted to provide his reaction to the summary feedback presented through option 1218, e.g., accepting, reflecting, upset, angry, or disbelief. The head teacher may also be instructed to spend some time reflecting on the daily events that the head teacher encounters as a head teacher, in light of the climate that the head teacher is perceived to create. For example, the head teacher can reflect upon the two incidents that were previously illustrated to and stored by the system. The summary of the incidents and the head teacher's reflection may be recalled from a database 106 for presentation to the head teacher. In order to help the head teacher reflect on the model data, and thus the perceived school climate, in light of the prior recorded incidents, the head teacher may be prompted to respond to a series of questions, such as by entering responses in narrative form in a text box presented to the head teacher with a user device 110 or 108. All responses may be recorded in a database 106 for later recall or editing. Examples of such questions may include the following: (a) “Which dimensions of climate are evident in these incidents, and are they different for each incident?”; (b) “Was there any particular dimension of climate that you feel helped in these situations, and if so, why?”; (c) Were particular dimensions more useful in one event, and less so in another? What were they, and why were they more useful?”; (d) “Looking back, do you think that a higher level of a particular dimension might have been beneficial in either event? If so, which dimension is that and why?”; (e) Is there any reason why you might have interpreted the climate differently from your colleagues in these events? What were those reasons, and what effect do you think they had?”; and (f) “Do you now think that there are particular dimensions that you would like to focus on? What are they?”.

Preferably after the head teacher has sufficiently reviewed and reflected upon the school climate data, the head teacher prioritizes particular classroom dimensions for development option 1220—“Prioritizing for Action.” The model data presented to the classroom teacher by options 1216, 1218 and the reflection instructions provided to the head teacher provide a good foundation for assessing possible development areas.

After the head teacher selects option 1220, the head teacher is preferably provided a summary of the priority level that the head teacher assigned to each climate dimension using option 1216. This summary may be provided to the head teacher in the manner described above in connection with FIG. 7, only with the school climate dimensions rather than the classroom climate dimensions. Again, the display preferably allows the head teacher to change a priority (e.g., from “high” to “low” or “medium”), such as by means of a pull down window. The “key message,” such as the key message described above in connection with FIG. 14E for the Responsibility dimension, is also preferably summarized for each dimension for the head teacher.

Option 1220 may also provide the head teacher with a summary of the head teacher's initial reaction to the feedback, which was provided by the head teacher for each climate dimension, e.g., whether the teacher was accepting, angry, reflective, etc. This may be accomplished through an interactive display as described in connection with FIG. 8 of the classroom teacher embodiment of the system. For example, a chart may be provided that lists each climate dimension, the head teacher's indicated priority level for development of each dimension, and the head teacher's reaction to the feedback for each climate dimension. This chart may be provided to the head teacher, along with an appropriate explanation, because strong negative feelings (e.g., anger, upset or disbelief) can act as a barrier to taking effective action with respect to an individual dimension. Therefore, the head teacher is preferably instructed that he should not take immediate action with respect to an individual dimension unless he has fully accepted the feedback for that dimension. At this stage, the head teacher is also provided the opportunity to modify his selected priorities and modify his indicated reactions to the model data to reflect his current feelings.

After the head teacher has been provided the model data representing the school climate, and preferably after the head teacher has reflected on this data, option 1220 allows the head teacher to select one or more school climate dimensions to develop. This selection may be made, for example, through a screen such as is shown in FIG. 9 and described above, only directed accordingly to the school climate dimensions rather that the classroom climate dimensions. The head teacher is preferably allowed to select up to three dimensions upon which to work. It is believed that selecting too many dimensions for development does not allow a head teacher to adequately focus on development of the selected dimensions. The head teacher is also preferably provided the opportunity to recall from database 106 his “aspirations” for review, which he recorded with option 1204. The head teacher is more likely to succeed if the changes he wants to make are linked to his personal goals and his goals for the school.

After the head teacher has selected or prioritized school climate dimensions to address, the head teacher reviews evaluation data that include leadership style data representing the perceived leadership styles of the head teacher. The head teacher can review this leadership style data using the “Exploring Your Leadership Styles” option 1222. The leadership style feedback data preferably indicate the head teacher's perception of the six leadership styles described above (authoritative, coaching, coercive, affiliative, democratic and pacesetting), the aggregate of school employees' perception of the head teacher's use of the six leadership styles, and a comparison between the head teacher's and the employees' perceptions. This data may be presented to the head teacher in a graphical format, such as in a table or chart, and/or in other formats, such as textually or numerically. This type of feedback can effectively indicate to the head teacher that the head teacher's perception of his leadership style is not always the same as that perceived by his colleagues under the day-to-day pressures of work. The feedback also helps identify for the head teacher the breadth of his application or use of the various leadership styles and indicates whether the head teacher overly relies on one or two leadership styles rather than relying on the full range of available leadership styles.

Once the head teacher has reviewed the leadership style evaluation data, the head teacher can consider the effect of the individual leadership styles on the school climate, and specifically on the school climate dimensions. The head teacher can select a specific style upon which to work that directly effects a climate dimension in need of development. The system then provides the head teacher with suggested actions to take to develop the leadership style. The impact of selected leadership styles on the climate dimensions selected by the head teacher with option 1220 may be provided to the head teacher with the “Exploring and Choosing Actions” option 1224.

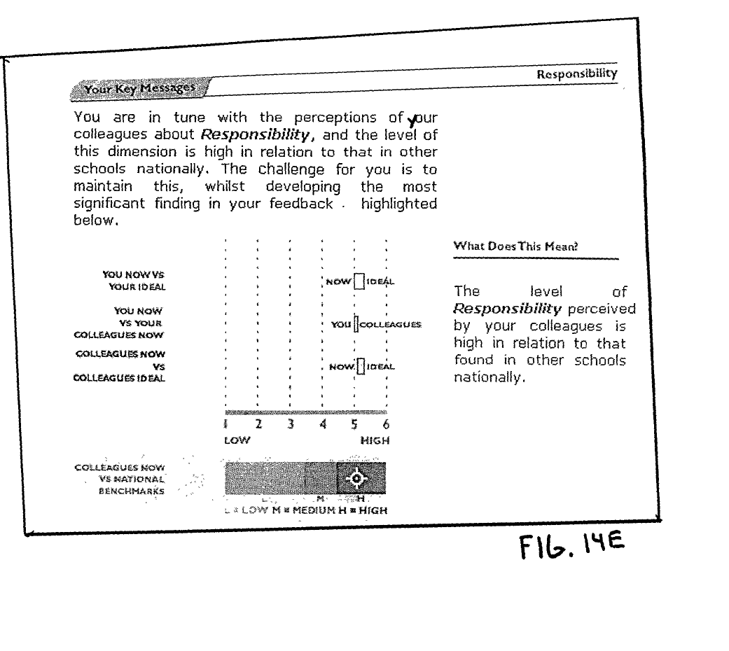

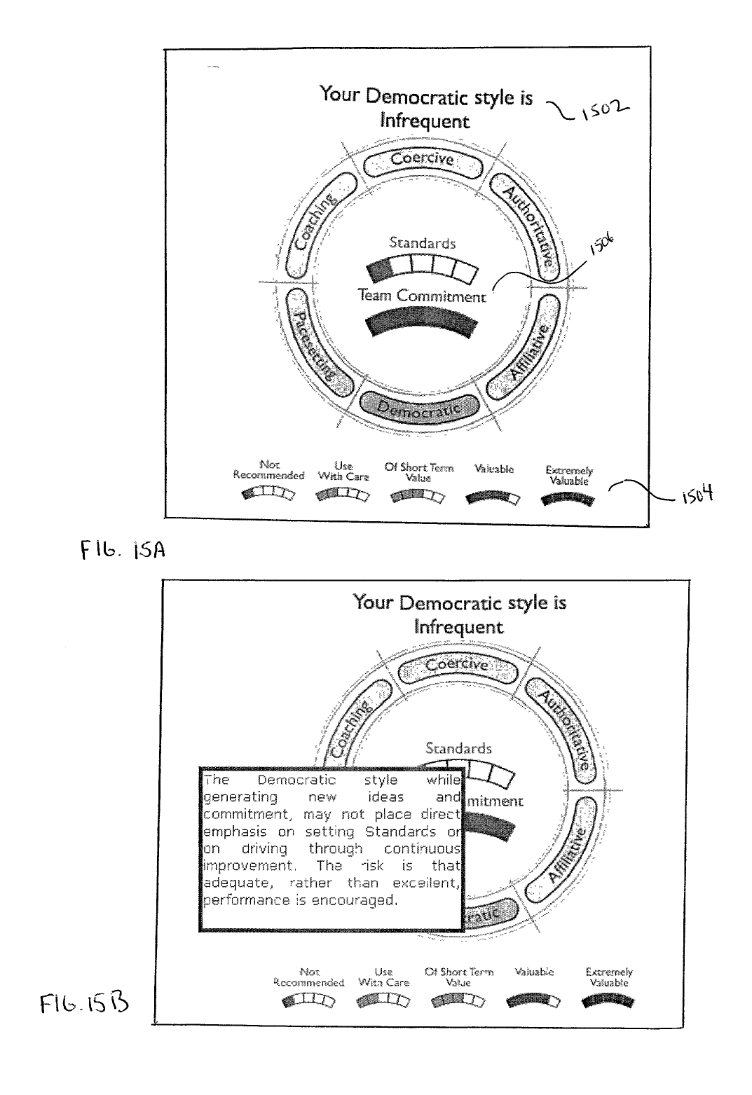

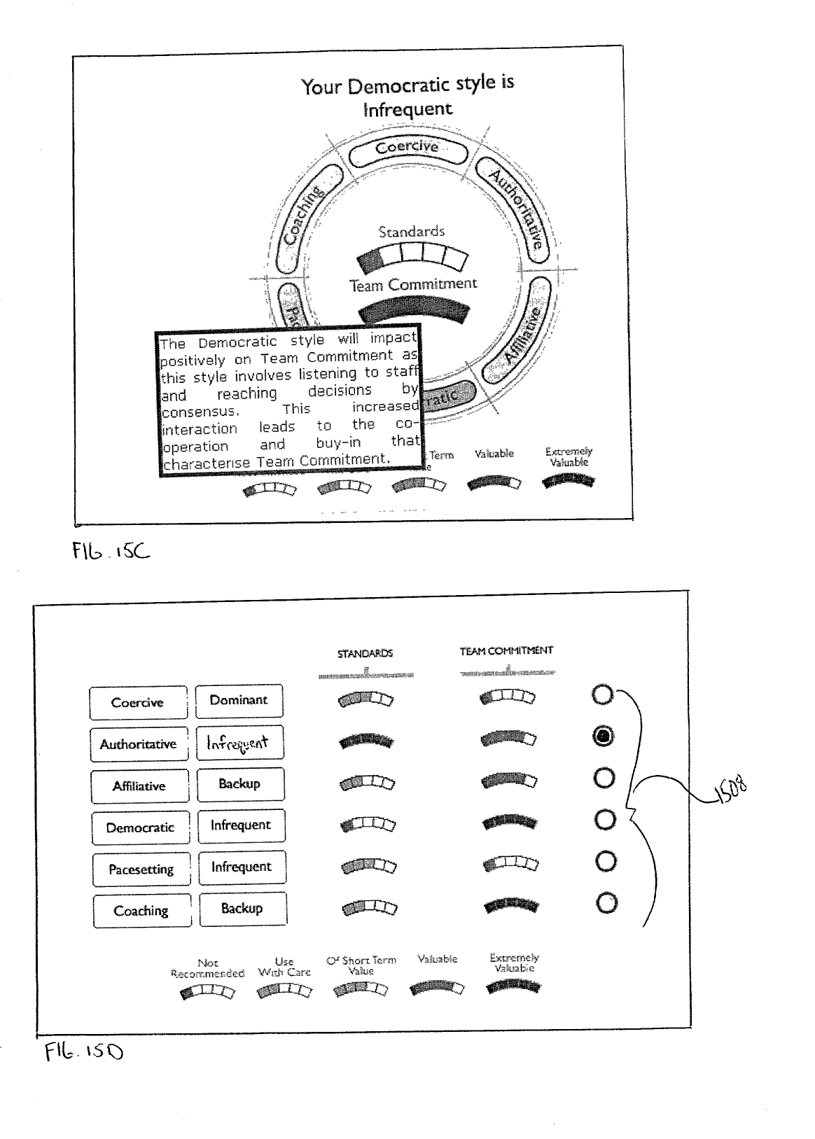

FIGS. 15A-C illustrate one combined graphical/textual manner of providing the head teacher this information. Referring to FIG. 15A, a chart listing the six leadership styles is shown. The head teacher can select one of the six leadership styles, such as by clicking on the leadership style name, and the effect of that particular leadership style on the selected climate dimension is illustrated for the head teacher. FIG. 15A indicates at 1502 that the head teacher has selected the “Democratic” style. As discerned from the evaluation data provided by the head teacher's employees, FIG. 15A also indicates at 1502 that the head teacher uses this style infrequently. At 1504, FIG. 15A provides a key indicating how the effect of a particular leadership style on a climate dimension is illustrated, i.e., with “extremely valuable” indicated with five highlighted blocks out of five, and of little value or “not recommended” indicated with one highlighted block out of five. Of course, this method is only one of many acceptable methods of illustrating the relative values of the use of a leadership style on a climate dimension. At 1506, FIG. 15A lists the climate dimension—“Standards” and “Team Commitment”—that the head teacher previously selected using option 1220. Also indicated at 1506, FIG. 15A indicates that the Democratic leadership style is extremely valuable in developing the Team Commitment climate dimension and is not recommended for developing the Standards climate dimension. These relative values may be retrieved from a database 106 of relative values, which is developed based upon research concerning the effects of leadership styles on school climate dimensions.

The head teacher may be provided additional information concerning the effect of the leadership style on a particular climate dimension in textual format by, for example, clicking on the climate dimension name or hovering a pointer controlled by a mouse or other interface device over the climate dimension name. Referring to FIG. 15B, if the head teacher requests additional information on the effect of the Democratic leadership style on the Standards dimension, the system may indicate to the head teacher, for example, the following: “The Democratic style, while generating new ideas and commitment, may not place direct emphasis on setting Standards or on driving through continuous improvement. The risk is that adequate, rather than excellent, performance is encouraged.” If, for example, the head teacher requests more information on the effect of the Democratic leadership style on the Team Commitment option, the system may indicate to the head teacher, as shown in FIG. 15C, the following: “The Democratic style will impact positively on Team Commitment as this style involves listening to staff and reaching decisions by consensus. This increased interaction leads to the cooperation and buy-in that characterize Team Commitment.”

Although information identifying the effect of a leadership style on climate dimensions is described above in connection with the Democratic style, this is for purposes of example only. The head teacher can request similar information for each indicated leadership style. The system includes a database 106 that includes information on the relative effects and value of leaderships styles on climate dimensions, as guided by research pertaining to these effects, and this information is selectively recalled as needed, i.e., based upon the dimensions selected by the head teacher using option 1220 and the requests of the head teacher as described above using option 1224.

As illustrated by FIG. 15D, the system through option 1224, may also provide the head teacher with a summary chart that summarizes the relative value of each leadership style in developing the selected climate dimensions. The chart may also be used to prompt the head teacher to select at least one leadership style for development, such as by clickable markers 1508. FIG. 15D indicates that the head teacher has selected the Authoritative style for development based upon its respective value in developing the Standards and Commitment climate dimensions. The head teacher is preferably, although not necessarily, provided the opportunity to select only one leadership style for development, so that the head teacher can concentrate sufficient efforts in adequately developing that style. This selection seems appropriate, being that the Authoritative leadership style is indicated as “extremely valuable in developing the Standards dimension and “valuable” in developing the Team Commitment dimension. Also, the chart indicates that the head teacher's use of this leadership style is “Infrequent.” The employees' perceptions of the head teacher's use of each style (e.g., dominant, backup, infrequent) is also preferably indicated for the head teacher

Once the head teacher has selected a leadership style to develop, the head teacher can use option 1224 to construct an action plan, such as in the manner described above in connection with option 222 of the classroom teacher embodiment. For example, the head teacher may be provided with a list of action points. By selecting one or more of the action points, the action point is included in the head teacher's action planner. Examples pertinent to the authoritative leadership style may include, for example: (1) “Consciously plan to use the Authoritative Style when articulating a new vision or clear direction for the school, when briefing a new member of the school team, and/or when introducing and setting standards and expectations.”; (2) “Review your use of this style at weekly intervals; the aim of your review should be to consider what you were trying to achieve when using the style, i.e., what led you to the use of the style? Who was involved? What was the outcome? Further, support your review by seeking feedback from colleagues.”; or (3) “Ensure that you balance the Authoritative style in your repertoire of leadership styles. Consider supplementing the style with styles such as Coaching and Democratic, enabling you to take advantage of the natural talents and ideas of knowledgeable members of the staff.” Alternatively or additionally, the teacher may be provided the opportunity to enter or create his own action point for inclusion within the action planner.

As described above, individual behavioral characteristics also effect individual leadership styles. Option 1224 also preferably prompts the head teacher to select various behavioral characteristics to develop, which effect individual leadership styles that, in turn, effect individual school climate dimensions. For the authoritative style, the head teacher may decide to take action with respect to (1) strategic thinking; (2) personal conviction; (3) transformational learning; and/ or (4) impact and influence (as indicated by the chart provided above). These characteristics are described in more detail above in connection with the fifteen characteristics of the Models of Excellence for Head Teachers and option 1212 (FIG. 12). Once the head teacher selects a characteristic upon which to work, the head teacher is provided at least one behaviorally based action points to select for inclusion in the head teacher's action planner. Alternatively or additionally, the head teacher can create his own action point. As an example, assume the head teacher opts to take action with respect to strategic thinking. The head teacher may then be prompted to select a statement with which the head teacher most agrees. For example the head teacher may be prompted to select between the following: (1) “I need to understand and practice this characteristic”; (2) I need to see the relevance and value of this characteristic”; and (3) “I need to feel comfortable and achieve a sense of satisfaction when using this characteristics.” Once the head teacher selects a statement, the head teacher is prompted to select at least one action point for addition to the head teacher's action planner. As an example, assume the head teacher selects “strategic thinking” for action and then selects the statement “I need to understand and practice this characteristic.” The teacher may then be prompted to select from the following action points: (1) “Make sure that you have enough information about your school and wider educational, social and community trends. Look for patterns in the information.”; (2) “Develop a system for receiving, analyzing and acting on new information.”; (3) “Regularly set aside planning time for yourself to think creatively about how to meet your challenges.”; (4) “Study trends in your community or school. Together with colleagues, draw conclusions and make plans to address issues.”; and “Input your own action point.”

Action points may include any number of possible tasks for a head teacher, including, for example, reading selected items, reflecting upon particular events or concepts, practicing particular leadership, styles, interviewing or observing colleagues, consciously suppressing a leadership style in particular situations through development of a characteristic, etc. Whatever the particular action or actions selected or provided by the head teacher for execution, these particular actions are included within an action planner for the head teacher. The action planner may be electronically stored in a database 106 for retrieval, and the system can be used to monitor and track completion of specific points in the action planner as well as to provide reminders. The head teacher may access the action planner by selecting option 1226 (FIG. 12). Developing this action plan is important to realizing significant improvement in characteristics and leadership styles, and consequently in a school dimension, and ultimately in the school climate as a whole.

For each action point or task selected by the head teacher, the head teacher is prompted to provide a target achievement date. The head teacher is also asked reflective questions to aid the head teacher in implementing each action point in his action plan. The head teacher preferably provides narrative answers to the questions, such as by typing the answer in a text window. The answers are stored in a database 106 for later retrieval and review. Examples of such questions include: (a) “What will the impact of this action be?”; (b) “What help and resources do you require?”; and (c) “How will you measure success?”.

An action plan preferably covers a finite period of time, such as a semester or school year for a head teacher. The action plan may be developed towards the beginning of a semester or school year, for example, with target achievement dates dated for sometime later in the semester or school year. The head teacher can access the action plan, such as by using a user device 110 or 108, through a network 114 or 102. For each action point, the head teacher enters a status, such as “not started,” “in progress” or “complete.” The action plan is preferably reconfigurable so that the head teacher can, for example, view all action points sharing the same status, such as “complete” or “in progress.”

The system also preferably provides the head teacher with periodic reminders of outstanding action points when the head teacher logs into the system or by other means, such as by electronic mail. Reminders may be provided to the head teacher through mailbox option 1228 of FIG. 12. It is also suggested that the head teacher review the action plan every couple of weeks or so in order to record any progress and to remind the head teacher of his goals and aspirations previously recorded in database 106. The head teacher can also re-review any of the concepts explained to the head teacher in his initial review or subsequent reviews of the information provided to the teacher via options 1204-1224, such as how a particular characteristic effects a leadership style and what leadership styles effect which classroom dimensions.

After several months, the head teacher should again designate a group of employees through option 1206 to fill out the questionnaires regarding the school climate. The designated employees may be the same employees as previously designated, but they need not be as long as they represent an adequate cross-section of the employee base. Once these employees have provided their responses to the questions and the head teacher has also completed his questionnaires, the school climate is again modeled, based in part upon this reevaluation data. This second model of the classroom climate, and its underlying dimensions, can be compared with the first set of model data to identify improvements and declines in the school climate generally and particularly, with respect to individual climate dimensions. This reevaluation should help the head teacher evaluate his progress and reevaluate and appropriately modify his action plan.

Referring again to FIG. 12, option 1230 (“Where I Last Left Off”) is similar to Option 228 (FIG. 2), only it provides a link for the head teacher directly to the last option (1204-1226) completed or partially completed by the head teacher. Option 1232 (“Questionnaire Tracker”) allows the head teacher to view a listing of the employees designated to complete questionnaires that have started or completed the questionnaires. Option 1234 (“The Main Home Page”) links the head teacher to the login screen or other home page not customized and directed to the head teacher.

Under the “Administration” heading of FIG. 12, options 1238, 1240 and 1242 provide similar options to the head teacher as options 236, 238 and 240, respectively, do for the classroom teacher as described above in connection with FIG. 2. Option 1236 (“Create Your School Manager Account”) allows the head teacher to review aggregate classroom climate data compiled from the evaluation data from the teachers. Evaluation data may be grouped so that classroom climate model data may be developed on a school-wide level, a grade level a departmental level or any other desired grouping. This data can then be compared (e.g., a first grade level verse a second grade level) or merely presented to a head teacher for review. In so doing, the head teacher can identify deficiencies in the school by grouped climate. For example, the best, average and worst scores can be identified. This data may also be compared to a national or regional benchmark.

Further, the priority data for each classroom dimension may be received from a plurality of classroom teachers that utilize the present system and method. This priority data may then be compared in order to identify a relative difference between respective averaged priority levels between dimensions. The comparison can be further conducted on a departmental, subject matter, or geographical basis. A head teacher may then use this data to discern the relative priorities of his or her faculty. In a similar manner, the dimension upon which teachers have selected to work can be identified and comparisons can be conducted on a departmental, subject matter or geographical basis. For example, the percentage of teachers that have chosen to work on the dimension of Clarity may be identified. When the head teacher holds a superintendent level position, e.g., the head teacher supervises several schools, this option may be used to compare schools within a school district or a school district against a national or other regional benchmark. Likewise, if the head teacher is a department head, classes can be compared within the department or against other departments.

While the system and method have been described above in connection with a teaching environment, the system and method may be utilized in other environments, such as in businesses generally, non-profit organizations, societies or other organized entities. For example, managers at all levels of an organization can use the system to model and evaluate the workplace environment based upon feedback from the managers themselves and their employees. The business climate can be modeled, and different leadership styles and behavioral characteristics can be selected for action in order to develop an action planner. The system can then be used to monitor the progress of the manager with respect to the action plan. The empirical data that supports such a system, i.e., the identity of various dimensions in the workplace, climate and leadership styles and characteristics that effect these dimensions, as well as actions that can be utilized to develop these styles and characteristics, are available through companies such as the Hay Group, the assignee of the present application, which have conducted extensive research in this area, and research done by others. Examples of this research may be found in George H. Litwin and Robert A. Stringer, Jr., Motivation and Organisational Climate, Division of Research Graduate School of Business Administration, Harvard University (1968) and Lyle M. Spencer, Jr., David C. McClelland and Singe M. Spencer, Competency Assessment Methods History and State of the Art, Hay McBer Research Press (1994).

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the method and system have been described as embodied within a system 100, the method may also be practiced utilizing exclusively or in part an oral or paper-based application of the method.

Although exemplary embodiments are described in detail above, the invention is not limited thereto. Rather, the invention should be construed broadly to include other variants and embodiments, which may be practiced within the scope and range of equivalents of the appended claims.

What is claimed is:

1. A method of assisting in development of an environment, comprising the steps of:
receiving evaluation data for said environment from at least one individual participating in said environment, said evaluation data representing impressions of said individual regarding said environment;
providing model data to an individual that is responsible at least in part for said environment, said model data representing one or more dimensions of said environment, said model data developed at least in part from said evaluation data, each of said one or more dimensions being associated with at least one characteristic of said individual responsible for said environment;
receiving from said individual responsible for said environment a selection of at least one of said one or more dimensions of said environment; and
providing said individual responsible for said environment an action plan for improving at least one characteristic associated with said selected dimension.

2. The method of claim 1, further comprising the step of receiving evaluation data for said environment from said individual that is responsible at least in part for said environment, said evaluation data representing an impression of said individual regarding said environment.

3. The method of claim 2, wherein:
said environment is a classroom teaching environment,
said at least one individual participating in said environment includes a first plurality of students, and
said individual responsible for said environment is a classroom teacher.

4. The method of claim 3, further comprising the step of receiving from said classroom teacher a designation of said first plurality of students participating in said classroom teaching environment, said first plurality of students being designated to provide said evaluation data.

5. The method of claim 3, wherein:
said evaluation data received from said first plurality of students identify a perception of a current state of said classroom teaching environment and an indication of an ideal state of said classroom teaching environment, and
said evaluation data received from said classroom teacher identify a perception of a current state of said classroom teaching environment and an indication of an ideal state of said classroom teaching environment.

6. The method of claim 3, wherein:
the model data identify a difference between a perception of said classroom teacher regarding an individual dimension from said one or more dimensions and an indication from said classroom teacher of an ideal state of said individual dimension;
the model data identify a difference between a perception of said plurality of students regarding an individual dimension from said one or more dimensions and an indication from said first plurality of students of an ideal state of said individual dimension;
the model data identify a difference between a perception of said classroom teacher regarding an individual dimension from said one ore more dimensions and a perception of said first plurality of students regarding said individual dimension;
the model data identify a difference between a perception of said first plurality of students regarding an individual dimension from said one or more dimensions and an indication from said classroom teacher of an ideal state of said individual dimension;
the model data identify a difference between a perception of said classroom teacher regarding an individual dimension from said one or more dimensions and an indication from said first plurality of students of an ideal state of said individual dimension;
the model data identify a difference between an indication from first said plurality of students of an ideal state of a dimension from said one or more dimension and an indication from said classroom teacher of an ideal state of said individual dimension;
the model data identify a difference between a perception of said first plurality of students regarding an individual dimension from said one or more dimensions and a community benchmark perception for said individual dimension; or a combination thereof.

7. The method of claim 6, wherein the step of providing the model data includes the step of providing the model data in a graphical format.

8. The method of claim 3, further comprising the steps of:
receiving from a second plurality of students reevaluation data for said selected classroom teaching environment, said reevaluation data representing impressions of said second plurality of students regarding said classroom teaching environment at a time after said evaluation data is received from said first plurality of students; and
providing second model data to said classroom teacher, said second model data representing said one or more dimensions of said classroom teaching environment, said second model data developed at least in part from said reevaluation data, each of said one or more dimensions being associated with at least one characteristic of said classroom teacher, said at least one characteristic known to effect a respective dimension.

9. The method of claim 8, further comprising the step of comparing said model data and said second model data.

10. The method of claim 8, wherein said second plurality of students includes one or more students from said first plurality of students.

11. The method of claim 3, wherein evaluation data are received for a plurality of classroom teaching environments, said method further comprising the step of:
providing aggregate model data identifying a difference between a school average for a dimension and a departmental average for a dimension, wherein more than one classroom environment from said plurality of classroom environments is associated with a department;
providing aggregate model data identifying a difference between a school average for a dimension and a grade level average for a classroom dimension, wherein more than one classroom environment from said plurality of classroom environments is associated with a grade level;
providing aggregate model data identifying a difference between a first departmental average for a dimension and a second departmental average for a dimension, wherein more than one classroom environment from said plurality of classroom environments is associated with a respective first and second departments;
providing aggregate model data identifying a difference between a first grade level average for a classroom dimension and a second grade level average for a classroom dimension, wherein more than one classroom environment from said plurality of classroom environments is associated with a respective first and second grade levels; or a combination thereof.

12. The method of claim 3, wherein a plurality of classroom teachers provide evaluation data for a plurality of classroom environments, the method further comprising the steps of:
receiving from said plurality of classroom teachers priority data for each of said one or more dimensions, said priority data identifying a respective priority level for each of said one or more dimensions; and
providing comparison data from said priority data, said comparison data identifying a relative difference between respective priority levels for said one or more dimensions.

13. The method of claim 1, wherein said evaluation data received from said at least one individual participating in said environment identify a perception of a current state of said environment and an indication of an ideal state of environment.

14. The method of claim 2, wherein:
said evaluation data received from said at least one individual participating in said environment identify a perception of a current state of said environment and an indication of an ideal sate of said environment, and
said evaluation data received from said individual responsible for said environment identify a perception of a current sate of said environment and an indication of an ideal state of said environment.

15. The method of claim 1, further comprising the steps of:
receiving from at least one individual participating in said environment reevaluation data for said selected environment, said reevaluation data representing impressions of said at least one individual regarding said environment at a time after said evaluation data is received; and
providing second model data to said individual responsible for said environment, said second model data representing said one or more dimensions of said environment, said second model data developed at least in part from said reevaluation data.

16. The method of claim 15, further comprising the step of comparing said model data and said second model data.

17. The method of claim 2, wherein:
said environment is a school environment,
said at least one individual participating in said environment includes a first plurality of employees within said school environment, and
said individual responsible for said environment is a head teacher.

18. The method of claim 17, further comprising the step of receiving from said head teacher a designation of said first plurality of employees participating in said school environment, said first plurality of employees being designated to provide said evaluation data.

19. The method of claim 17, wherein:
said evaluation data received from said first plurality of employees identify a perception of a current state of said school environment and an indication of an ideal state of said school environment, and
said evaluation data received from said head teacher identify a perception of a current state of said school environment and an indication of an ideal state of said school environment.

20. The method of claim 17, wherein:
the model data identify a difference between a perception of said head teacher regarding an individual dimension from said one or more dimensions and an indication from said head teachers of an ideal state of said individual dimension;
the model data identify a difference between a perception of said first plurality of employees regarding an individual dimension from said one or more dimensions and an indication from said first plurality of employees of an ideal state of said individual dimension;
the model data identify a difference between a perception of said head teacher regarding an individual dimension from said one ore more dimensions and a perception of said first plurality of employees regarding said individual dimension;
the model data identify a difference between a perception of said plurality of classroom teachers regarding an individual dimension from said one or more dimensions and an indication from said head teacher of an ideal state of said individual dimension;
the model data identify a difference between a perception of said head teacher regarding an individual dimension from said one or more dimensions and an indication from said first plurality of employees of an ideal state of said individual dimension;
the model data identify a difference between an indication from said first plurality of employees of an ideal state of a dimension from said one or more dimension and an indication from said head teacher of an ideal state of said individual dimension;
the model data identify a difference between a perception of said first plurality of employees regarding an individual dimension from said one or more dimensions and a community benchmark perception for said individual dimension; or a combination thereof.

21. The method of claim 20, wherein the step of providing the model data includes the step of providing the model data in a graphical format.

22. The method of claim 17, further comprising the steps of:
receiving from a second plurality of employees reevaluation data for said selected school environment, said reevaluation data representing impressions of said second plurality of employees regarding said school environment at a time after said evaluation data is received from said first plurality of employees; and
providing second model data to said head teacher, said second model data representing said one or more dimensions of said school environment, said second model data developed at least in part from said reevaluation data.

23. The method of claim 22, further comprising the step of comparing said model data and said second model data.

24. The method of claim 22, wherein said second plurality of employees includes one or more employees from said first plurality of employees.

25. The method of claim 17, wherein:
said evaluation data received from said plurality of teachers include first leadership style data, said first leadership style data identifying a perception by said plurality of teachers of the use of a plurality of different leadership styles by said head teacher; and
said evaluation data received from said head teacher include second leadership style data identifying a perception by said head teacher of the use of said plurality of different leadership styles by said head teacher.

26. The method of claim 25, further comprising the step of providing leadership model data, said leadership model data representing usage of said plurality of leadership styles by said head teacher, said leadership model data being developed at least in part from said first leadership style data and said second leadership style data.

27. The method of claim 25, wherein the step of receiving from said head teacher a selection of at least one of said one or more dimensions includes the step of receiving an identification of one or more leadership styles from said plurality of different leadership styles, said one or more leadership styles being associated with at least one of said one or more dimensions.

28. The method of claim 27, further comprising the step of providing said head teacher an action plan for improving said selected one or more leadership styles.

29. The method of claim 27, further comprising the step of providing said head teacher an action plan for improving at least one characteristic of said head teacher associated with said identified one or more leadership styles.

30. The method of claim 2, wherein:
said evaluation data received from said first at least one individual participating in said environment identify a perception of a current state of said environment and an indication of an ideal state of said environment, and
said evaluation data received from said individual that is responsible at least in part for said environment identify a perception of a current state of said environment and an indication of an ideal state of said environment.

31. The method of claim 2, wherein:
said evaluation data received from said at least one individual participating in said environment include first leadership style data, said first leadership style data identifying a perception of the use of a plurality of different leadership styles by said individual that is responsible for said environment; and
said evaluation data received from said individual that is responsible at least in part for said environment include second leadership style data identifying a perception by said individual that is responsible at least in part for said environment of the use of said plurality of different leadership styles by said individual that is responsible for said environment.

32. The method of claim 31, further comprising the step of providing leadership model data, said leadership model data representing usage of a plurality of leadership styles by said individual that is responsible for said environment, said leadership model data being developed at least in part from said first leadership style data and said second leadership style data.

33. The method of claim 31, wherein the step of receiving from said individual responsible for said environment a selection of at least one of said one or more dimensions includes the step or receiving an identification of one or more leadership styles from said plurality of leadership styles, said one or more leadership styles being associated with said selected at least one of said one or more dimensions.

34. The method of claim 33, further comprising the step of providing said individual responsible for said environment an action plan for improving said selected one or more leadership styles.

35. The method of claim 33, further comprising the step of providing said individual responsible for said environment an action plan for improving at least one characteristic of said individual responsible for said environment associated with said identified one or more leadership styles.

36. A computer-readable medium encoded with a computer program code for directing a processor to assist in the development of an environment, comprising:
a first code segment for causing a processor to provide model data to an individual that is responsible at least in part for said environment, said model data representing one or more dimensions of said environment, said model data developed at least in part from evaluation data, said evaluation data being received from at least one individual participating in said environment and representing impressions of said individual regarding said environment, each of said one or more dimensions being associated with at least one characteristic of an individual responsible for said environment;
a second code segment for causing the processor to receive from said individual responsible for said environment a selection of at least one of said one or more dimensions; and
a third code segment for causing the processor to provide said individual responsible for said environment an action plan for improving at least one characteristic associated with said selected dimension.

37. The medium of claim 36, wherein said evaluation data further represents an impression regarding said environment of said individual that is responsible at least in part for said environment.

38. The medium of claim 37, wherein:
said environment is a classroom teaching environment,
said at least one individual participating in said environment includes a first plurality of students, and
said individual responsible for said environment is a classroom teacher.

39. The medium of claim 38, wherein:
said evaluation data received from said plurality of students identify a perception of a current state of said classroom teaching environment and an indication of an ideal state of said classroom teaching environment, and
said evaluation data received from said classroom teacher identify a perception of a current state of said classroom teaching environment and an indication of an ideal state of said classroom teaching environment.

40. The medium of claim 38, wherein:
the model data identify a difference between a perception of said classroom teacher regarding an individual dimension from said one or more dimensions and an indication from said classroom teacher of an ideal state of said individual dimension;
the model data identify a difference between a perception of said plurality of students regarding an individual dimension from said one or more dimensions and an indication from said first plurality of students of an ideal state of said individual dimension;
the model data identify a difference between a perception of said classroom teacher regarding an individual dimension from said one ore more dimensions and a perception of said first plurality of students regarding said individual dimension;
the model data identify a difference between a perception of said first plurality of students regarding an individual dimension from said one or more dimensions and an indication from said classroom teacher of an ideal state of said individual dimension;
the model data identify a difference between a perception of said classroom teacher regarding an individual dimension from said one or more dimensions and an indication from said first plurality of students of an ideal state of said individual dimension;
the model data identify a difference between an indication from first said plurality of students of an ideal state of a dimension from said one or more dimension and an indication from said classroom teacher of an ideal state of said individual dimension;
the model data identify a difference between a perception of said first plurality of students regarding an individual dimension from said one or more dimensions and a community benchmark perception for said individual dimension; or a combination thereof.

41. The medium of claim 38, wherein evaluation data is received for a plurality of classroom teaching environments, said medium further comprising:
a fourth code segment for causing said processor to provide aggregate model data identifying a difference between a school average for a dimension and a departmental average for a dimension, wherein more than one classroom environment from said plurality of classroom environments is associated with a department;
a fifth code segment for causing said processor to provide aggregate model data identifying a difference between a school average for a dimension and a grade level average for a classroom dimension, wherein more than one classroom environment from said plurality of classroom environments is associated with a grade level;
a sixth code segment for causing said processor to provide aggregate model data identifying a difference between a first departmental average for a dimension and a second departmental average for a dimension, wherein more than one classroom environment from said plurality of classroom environments is associated with a respective first and second departments; and
a seventh code segment for causing said processor to provide aggregate model data identifying a difference between a first grade level average for a classroom dimension and a second grade level average for a classroom dimension, wherein more than one classroom environment from said plurality of classroom environments is associated with a respective first and second grade levels; or a combination thereof.

42. The medium of claim 38, wherein a plurality of classroom teachers provide evaluation data for a plurality of classroom environments, the medium further comprising:
a fourth code segment for causing the processor to receive from said plurality of classroom teachers priority data for each of said one or more dimensions, said priority data identifying a respective priority level for each of said one or more dimensions; and
a fifth code segment for causing the processor to provide comparison data from said priority data, said comparison data identifying a relative difference between respective priority levels for said one or more dimensions.

43. The medium of claim 36, wherein said evaluation data received from said at least one individual participating in said environment identify a perception of a current state of said environment and an indication of an ideal state of said environment.

44. The medium of claim 37, wherein:
said evaluation data received from said at least one individual participating in said environment identify a perception of a current state of said environment and an indication of an ideal sate of said environment, and
said evaluation data received from said individual responsible for said environment identify a perception of a current sate of said environment and an indication of an ideal state of said environment.

45. The medium of claim 37, wherein:
said environment is a school environment,
said at least one individual participating in said environment includes a first plurality of employees within said school environment, and
said individual responsible for said environment is a head teacher.

46. The medium of claim 35, wherein:
said evaluation data received from said first plurality of employees identify a perception of a current state of said school environment and an indication of an ideal state of said school environment, and
said evaluation data received from said head teacher identify a perception of a current state of said school environment and an indication of an ideal state of said school environment.

47. The medium of claim 35, wherein:
the model data identify a difference between a perception of said head teacher regarding an individual dimension from said one or more dimensions and an indication from said head teachers of an ideal state of said individual dimension;
the model data identify a difference between a perception of said first plurality of employees regarding an individual dimension from said one or more dimensions and an indication from said first plurality of employees of an ideal state of said individual dimension;
the model data identify a difference between a perception of said head teacher regarding an individual dimension from said one ore more dimensions and a perception of said first plurality of employees regarding said individual dimension;
the model data identify a difference between a perception of said plurality of classroom teachers regarding an individual dimension from said one or more dimensions and an indication from said head teacher of an ideal state of said individual dimension;
the model data identify a difference between a perception of said head teacher regarding an individual dimension from said one or more dimensions and an indication from said first plurality of employees of an ideal state of said individual dimension;
the model data identify a difference between an indication from said first plurality of employees of an ideal state of a dimension from said one or more dimension and an indication from said head teacher of an ideal state of said individual dimension;
the model data identify a difference between a perception of said first plurality of employees regarding an individual dimension from said one or more dimensions and a community benchmark perception for said individual dimension; or a combination thereof.

48. The medium of claim 45, wherein:
said evaluation data received from said plurality of teachers include first leadership style data, said first leadership style data identifying a perception by said plurality of teachers of the use of a plurality of different leadership styles by said head teacher; and
said evaluation data received from said head teacher include second leadership style data identifying a perception by said head teacher of the use of said plurality of different leadership styles by said head teacher.

49. The medium of claim 48, further comprising a fourth code segment for causing said processor to provide leadership model data, said leadership model data representing usage of said plurality of leadership styles by said head teacher, said leadership model data being developed at least in part from said first leadership data and said second leadership style data.

50. The medium of claim 48, wherein the second code segment includes a code segment for causing the processor to receive an identification of one or more leadership styles from said plurality of different leadership styles, said one or more leadership styles being associated with said selected at least one of said one or more dimensions.

51. The medium of claim 50, further comprising a fourth code segment for causing the processor to provide said head teacher with an action plan for improving said selected one or more leadership styles.

52. The medium of claim 50, further comprising a fourth code segment for causing the processor to provide said head teacher with an action plan for improving a characteristic of said head teacher associated with said identified one or more leadership styles.

53. A data signal embodied in a carrier wave encoded with computer program code for directing a processor to assist in the development of an environment, comprising:
a first code segment for causing the processor to provide model data to an individual that is responsible at least in part for said environment, said model data representing one or more dimensions of said environment, said model data developed at least in part from evaluation data, said evaluation data being received from at least one individual participating in said environment and representing impressions of said individual regarding said environment, each of said one or more dimensions being associated with at least one characteristic of an individual responsible for said environment;
a second code segment for causing the processor to receive from said individual responsible for said environment a selection of at least one of said one or more dimensions; and
a third code segment for causing the processor to provide said individual responsible for said environment an action plan for improving at least one characteristic associated with said selected dimension.

54. The signal of claim 53, wherein said evaluation data further represents an impression regarding said environment of said individual that is responsible at least in part for said environment.

55. The signal of claim 54, wherein:
said environment is a classroom teaching environment,
said at least one individual participating in said environment includes a first plurality of students, and
said individual responsible for said environment is a classroom teacher.

56. The signal of claim 55, wherein:
said evaluation data received from said plurality of students identify a perception of a current state of said classroom teaching environment and an indication of an ideal state of said classroom teaching environment, and
said evaluation data received from said classroom teacher identify a perception of a current state of said classroom teaching environment and an indication of an ideal state of said classroom teaching environment.

57. The signal of claim 55, wherein:
the model data identify a difference between a perception of said classroom teacher regarding an individual dimension from said one or more dimensions and an indication from said classroom teacher of an ideal state of said individual dimension;
the model data identify a difference between a perception of said plurality of students regarding an individual dimension from said one or more dimensions and an indication from said first plurality of students of an ideal state of said individual dimension;
the model data identify a difference between a perception of said classroom teacher regarding an individual dimension from said one ore more dimensions and a perception of said first plurality of students regarding said individual dimension;
the model data identify a difference between a perception of said first plurality of students regarding an individual dimension from said one or more dimensions and an indication from said classroom teacher of an ideal state of said individual dimension;
the model data identify a difference between a perception of said classroom teacher regarding an individual dimension from said one or more dimensions and an indication from said first plurality of students of an ideal state of said individual dimension;
the model data identify a difference between an indication from first said plurality of students of an ideal state of a dimension from said one or more dimension and an indication from said classroom teacher of an ideal state of said individual dimension;
the model data identify a difference between a perception of said first plurality of students regarding an individual dimension from said one or more dimensions and a community benchmark perception for said individual dimension; or a combination thereof.

58. The signal of claim 55, wherein evaluation data is received for a plurality of classroom teaching environments, said medium further comprising:
a fourth code segment for causing the processor to provide aggregate model data identifying a difference between a school average for a dimension and a departmental average for a dimension, wherein more than one classroom environment from said plurality of classroom environments is associated with a department;
a fifth code segment for causing the processor to provide aggregate model data identifying a difference between a school average for a dimension and a grade level average for a classroom dimension, wherein more than one classroom environment from said plurality of classroom environments is associated with a grade level;
a sixth code segment for causing the processor to provide aggregate model data identifying a difference between a first departmental average for a dimension and a second departmental average for a dimension, wherein more than one classroom environment from said plurality of classroom environments is associated with a respective first and second departments; and
a seventh code segment for causing the processor to provide aggregate model data identifying a difference between a first grade level average for a classroom dimension and a second grade level average for a classroom dimension, wherein more than one classroom environment from said plurality of classroom environments is associated with a respective first and second grade levels; or a combination thereof.

59. The signal of claim 55, wherein a plurality of classroom teachers provide evaluation data for a plurality of classroom environments, the medium further comprising:
a fourth code segment for causing the processor to receive from said plurality of classroom teachers priority data for each of said one or more dimensions, said priority data identifying a respective priority level for each of said one or more dimensions; and
a fifth code segment for causing the processor to provide comparison data from said priority data, said comparison data identifying a relative difference between respective priority levels for said one or more dimensions.

60. The signal of claim 53, wherein said evaluation data received from said at least one individual participating in said environment identify a perception of a current state of said environment and an indication of an ideal state of said environment.

61. The signal of claim 54, wherein:
said evaluation data received from said at least one individual participating in said environment identify a perception of a current state of said environment and an indication of an ideal sate of said environment, and
said evaluation data received from said individual responsible for said environment identify a perception of a current sate of said environment and an indication of an ideal state of said environment.

62. The signal of claim 54, wherein:
said environment is a school environment,
said at least one individual participating in said environment includes a plurality of employees within said school environment, and
said individual responsible for said environment is a head teacher.

63. The signal of claim 52, wherein:
said evaluation data received from said first plurality of employees identify a perception of a current state of said school environment and an indication of an ideal state of said school environment, and
said evaluation data received from said head teacher identify a perception of a current state of said school environment and an indication of an ideal state of said school environment.

64. The signal of claim 52, wherein:
the model data identify a difference between a perception of said head teacher regarding an individual dimension from said one or more dimensions and an indication from said head teachers of an ideal state of said individual dimension;
the model data identify a difference between a perception of said first plurality of employees regarding an individual dimension from said one or more dimensions and an indication from said first plurality of employees of an ideal state of said individual dimension;
the model data identify a difference between a perception of said head teacher regarding an individual dimension from said one ore more dimensions and a perception of said first plurality of employees regarding said individual dimension;
the model data identify a difference between a perception of said plurality of classroom teachers regarding an individual dimension from said one or more dimensions and an indication from said head teacher of an ideal state of said individual dimension;
the model data identify a difference between a perception of said head teacher regarding an individual dimension from said one or more dimensions and an indication from said first plurality of employees of an ideal state of said individual dimension;
the model data identify a difference between an indication from said first plurality of employees of an ideal state of a dimension from said one or more dimension and an indication from said head teacher of an ideal state of said individual dimension;
the model data identify a difference between a perception of said first plurality of employees regarding an individual dimension from said one or more dimensions and a community benchmark perception for said individual dimension; or a combination thereof.

65. The signal of claim 62, wherein:
said evaluation data received from said plurality of teachers include first leadership style data, said first leadership style data identifying a perception by said plurality of teachers of the use of a plurality of different leadership styles by said head teacher; and
said evaluation data received from said head teacher include second leadership style data identifying a perception by said head teacher of the use of said plurality of different leadership styles by said head teacher.

66. The signal of claim 65, further comprising a fourth code segment for causing the processor to provide leadership model data, said leadership model data representing usage of said plurality of leadership styles by said head teacher, said leadership model data being developed at least in part from said first leadership data and said second leadership style data.

67. The signal of claim 65, wherein the second code segment includes a code segment for causing the processor to receive an identification of one or more leadership styles from said plurality of different leadership styles, said one or more leadership styles being associated with said selected at least one of said one or more dimensions.

68. The signal of claim 67, further comprising a fourth code segment for causing the processor to provide said head teacher with an action plan for improving said selected one or more leadership styles.

69. The signal of claim 67, further comprising a fourth code segment for causing the processor to provide said head teacher with an action plan for improving a characteristic of said head teacher associated with said identified one or more leadership styles.

70. A method of assisting in development of an environment, comprising the steps of:
receiving evaluation data for said environment from at least one individual participating in said environment, said evaluation data representing impressions of said individual regarding said environment; and
providing model data to an individual that is responsible at least in part for said environment, said model data representing one or more dimensions of said environment, said model date developed at least in part from said evaluation data.

71. The method of claim 70, further comprising the step of receiving evaluation data for said environment from said individual that is responsible at least in part for said environment, said evaluation data representing an impression of said individual regarding said environment.

72. The method of claim 71, wherein said model data are developed at least in part from said evaluation data received from said individual that is responsible at least in part for said environment.

73. The method of claim 71, wherein:
said evaluation data received from said at least one individual participating in said environment include first leadership style data, said first leadership style data identifying a perception of the use of a plurality of different leadership styles by said individual that is responsible for said environment; and
said evaluation data received from said individual that is responsible at least in part for said environment include second leadership style data identifying a perception by said individual responsible at least in part for said environment of the use of said plurality of different leadership styles by said individual that is responsible for said environment.

74. The method of claim 73, further comprising the step of providing leadership model data, said leadership model data representing usage of a plurality of leadership styles by said individual that is responsible for said environment, said leadership model data being developed at least in part from said first leadership style data and said second leadership style data.

75. The method of claim 71, wherein:
said evaluation data received from said at least one individual participating in said environment identify a perception of a current state of said environment and an indication of an ideal sate of said environment, and
said evaluation data received from said individual responsible for said environment identify a perception of a current sate of said environment and an indication of an ideal state of said environment.
